(19) United States
(12) Patent Application Publication
(10) Pub. No.: US 2004/0107223 A1
(43) Pub. Date: Jun. 3, 2004

(54) File management method

(76) Inventors: Shinichiro Uno, Kanagawa (JP); Takaaki Ashinuma, Ohta-ku (JP); Yukinori Yamamoto, Kabushiki (JP); Masanori Ito, Osaka (JP); Masafumi Shimotashiro, Katano-shi (JP); Tadashi Nakamura, Nara (JP); Makoto Mitsuda, Osaka (JP)

Correspondence Address: FITZPATRICK CELLA HARPER & SCINTO, 30 ROCKEFELLER PLAZA, NEW YORK, NY, 10112, US

(21) Appl. No.: 10/471,529

(22) PCT Filed: Mar. 28, 2002
(86) PCT No.: PCT/JP02/03059

(30) Foreign Application Priority Data
Mar. 30, 2001 (JP) 2001-100941

(51) Int. Cl. G06F 17/30

(52) U.S. Cl. 707/200

(57) ABSTRACT

A file management method has highly general versatility among applications, does not waste recording area, and facilitates handling of volumes of discrete and grouped files and group information. A recording medium for use in the file management method.

A contents management file (CMF) is provided for collectively all of necessary files and all groups, so that application can deal with volumes of filed on a disk through CMF without direct communication with the file systems and a necessitating the grouping can be performed in highly general versatility.

### TECHNICAL FIELD

The present invention relates to a method of managing files included in a recording medium.

### BACKGROUND ART

In the conventional technology, when applications such as image display software, electronic album software, etc. handled information such as moving images, still images, audio, etc. included in a recording medium such as an optical disk, a magnetic disk, a magnetooptical disk, or the like, they made access to each information on the disk through a file system such as UDF, FAT, or the like, as shown in FIG. 2A.

When grouping of some files became necessary in printing, list display, slide shows, etc., management files describing member files and necessary information were prepared according to respective groups like a play list file, a DPOF file, etc., and management of the grouping files was performed.

However, when the applications directly utilized the file systems to make access to each file as in the conventional system shown in FIG. 2A, it became hard to manage the files and groups generally with increase in the number of files and the number of groups and there arose the problem that a considerable time was necessary for searching for necessary information. Further, for specifying a file through the file system, a type of the file must be judged from its extension, and it was not easy to discriminate files with the same type of extension, e.g. video and audio files, from each other, which was hindrance to quick search.

For time series reproduction of a plurality of recorded files, it was necessary to sort the files in an order of recording times by accessing all the files. In this case, it was possible to employ a scheme of saving time series information with some means for the directory structure and file names, but this scheme decreased the degrees of freedom in the directory structure and file names and was thus inconvenient in terms of file management.

In the case of the aforementioned method using the management files, it was necessary to prepare the management files for the respective groups. For this reason, in order to gain information about members or the like included in each management file, each management file must be expressly opened and checked and this was inconvenient in terms of file management. Further, in order to determine whether a certain file was included in either of the management files, all the management files must be opened and checked, and it was hard to determine whether a file to be deleted or the like was included in the management files. In addition, the management files were described in different formats according to the applications utilizing the management files and thus there was the problem on general versatility that a management file for a certain application was not applicable to another application.

In use of the management files, the applications directly used the file system in order to make access to each file, and there was thus no solution given to the problem that the considerable time was necessary for the search for necessary information.

### DISCLOSURE OF THE INVENTION

The present invention has been accomplished in view of the above problems and an object of the invention is to provide a file management method that has high general versatility among applications and that facilitates handling of volumes of file and group information.

The following presents an example for accomplishing the above object.

A file management method according to the present invention is a method of managing files recorded on an information recording medium, wherein there is provided a Contents Management File comprising group information about groups into which a plurality of files recorded on the medium are grouped and wherein management of the groups and files is carried out by means of the Contents Management File.

In the present invention, as shown in FIG. 2B, there is provided the CMF (Contents Management File) which is a file for generally managing all the necessary files and groups; this allows the applications to handle a lot of files on the disk through the CMF without direct communication with the file system and to perform the necessary processing such as the grouping or the like with general versatility.

### BRIEF DESCRIPTION OF THE DRAWINGS

FIG. 1 is a diagram showing the overall structure of the Contents Management File.

FIGS. 2A and 2B are diagrams showing the role of the Contents Management File.

FIG. 3 is a diagram showing the structure of Management Information.

FIG. 4 is a diagram showing the structure of General Information.

FIG. 5 is a diagram showing the structure of File Type Table.

FIG. 6 is a diagram showing the structure of Vendor ID Table.

FIG. 7 is a diagram showing the structure of Block Type Table.

FIG. 8 is a diagram showing the structure of Information Block Type Descriptor.

FIG. 9 is a diagram showing an Information Type list.

FIG. 10 is a diagram showing the structure of Number Management Table.

FIG. 11 is a diagram showing the structure of Information Block Descriptor.

FIG. 12 is a diagram showing the structure of Block Specified Data.

FIG. 13 is a diagram showing the structure of Parent/Child Group Information Block.

FIG. 14 is a diagram showing the structure of Group Descriptor.

FIG. 15 is a diagram showing the structure of Extended Data.

FIG. 16 is a diagram showing the structure of Data Element.

FIG. 17 is a diagram showing a Data Type list.

FIG. 18 is a diagram showing an example of missing Group IDs.

FIG. 19 is a diagram showing the structure of Parent/Child Group Member Information Block.

FIG. 20 is a diagram showing the structure of Parent/Child Group Member Descriptor.

FIG. 21 is a diagram showing the structure of File Information.

FIG. 22 is a diagram showing the structure of File Descriptor.

FIG. 23 is a diagram showing an example of missing File IDs.

FIG. 24 is a diagram showing the structure of Text Information.

FIG. 25 is a diagram showing the structure of Text Descriptor.

FIG. 26 is a diagram showing the directory structure in the disk.

FIG. 27 is a diagram showing the directory structure at the time of initialization of the disk.

FIG. 28 is a diagram showing the CMF structure immediately after initialization of the disk.

FIG. 29 is a diagram showing the directory structure immediately after addition of a file (TAKE0001.MPG).

FIG. 30 is a diagram showing the CMF structure immediately after addition of the file (TAKE0001.MPG).

FIG. 31 is a diagram showing the directory structure immediately after addition of a play list (PLAY0001.XML).

FIG. 32 is a diagram showing the CMF structure immediately after addition of the play list (PLAY0001.XML).

FIG. 33 is a diagram showing the CMF structure immediately after addition of a child group with a comment including many files.

FIG. 34 is a diagram showing the CMF structure immediately after addition of a new Member Descriptor with addition of a member to a child group.

FIG. 35 is a diagram showing the CMF structure immediately after addition of a parent group with a comment.

FIG. 36 is a diagram showing the number of data filling up the entire capacity of the CMF obtained at the time of initialization.

FIG. 37 is a diagram showing a case of adding a new File Information Block to the CMF.

FIG. 38 is a diagram showing a case of adding a new Child Group Member Information Block to the CMF.

FIG. 39 is a diagram showing a case of adding new Child-Group/Text Information Blocks to the CMF.

FIG. 40 is a diagram showing a case of adding a Group Member Descriptor to an Information Block with no blank area.

FIG. 41 is a diagram showing a case of deletion of one file.

FIG. 42 is a diagram showing a case of deletion of one child group with a comment consisting of two Member Descriptors.

FIG. 43 is a diagram showing a processing routine of the CMF file.

FIG. 44 is a diagram showing a routine of adding a new Information Block.

FIG. 45 is a diagram showing a routine of adding new group information/file information/text information.

FIG. 46 is a diagram showing a routine of adding new group member information.

FIG. 47 is a diagram showing a routine of deleting file information.

FIG. 48 is a diagram showing a routine of deleting text information.

FIG. 49 is a diagram showing a routine of deleting child group information.

FIG. 50 is a diagram showing a routine of deleting parent group information.

FIG. 51 is a diagram showing a routine of moving group member information.

FIG. 52 is a diagram showing a routine of adding a member to a group.

FIG. 53 is a diagram showing a routine of deleting a member from a group.

FIG. 54 is a diagram showing a relation among Descriptors in the CMF.

FIG. 55 is a diagram showing an example of display of a parent group list.

FIG. 56 is a diagram showing an example of display of a child group list.

FIG. 57 is a diagram showing an example of display of a file list.

### BEST MODE FOR CARRYING OUT THE INVENTION

1. Structure of CMF

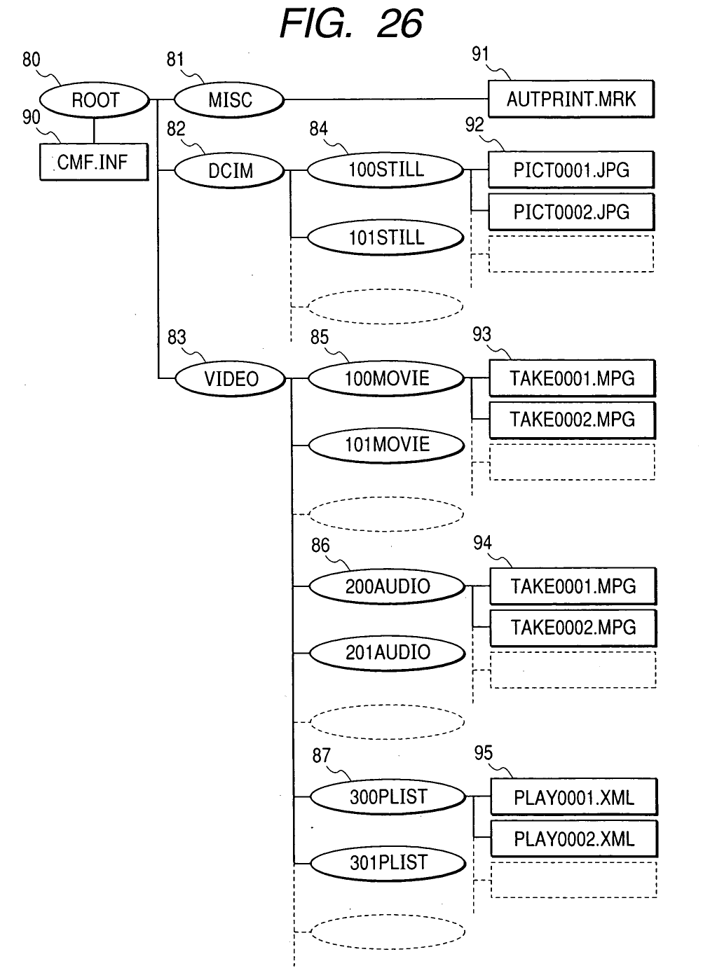

First, the structure of the CMF (Contents Management File) will be described. It is noted herein that the directory structure, file names, specific values of the CMF, etc. described below are just an example and that the present invention can also be applied to cases different from the present embodiment. For recording data in the disk or the like, it is common practice to use the directory structure based on the file system such as FAT, UDF, or the like and record files therein. FIG. 26 shows an example of the directory structure managed this time by the CMF, in which under a ROOT directory [80] there are a MISC directory [81] for management of print or the like, a DCIM directory [82] for recording of still images, and a VIDEO directory [83] for recording of moving images (movies), audio, play lists, and so on. Under the DCIM directory [82] there exist still image directories [84] each with a number of three digits at the head. Under the VIDEO directory [83] there exist movie directories [85] each with a number of three digits at the head, audio directories [86], and play list directories [87]. The three-digit numbers at the head of the respective directory names are determined so that the same three-digit number is not assigned to different directories of the same kind. Recorded under the still image, movie, audio, and play list directories are still image files [92], movie files [93], audio files [94], and play list files [95], respectively, each of which has a file name with a number of four digits following alphanumerics of four characters at the head. The four-digit numbers in the file names are determined so that the same four-digit number is not assigned to different files of the same kind in the same directory. The CMF is a file of managing these files, grouping of files, etc., and the CMF has general versatility and thus can be accessed from a plurality of applications (FIGS. 2A and 2B). Since the CMF itself is a file [90] managed by the file system, it is stored somewhere on the disk (under the ROOT directory [80] in the present embodiment).

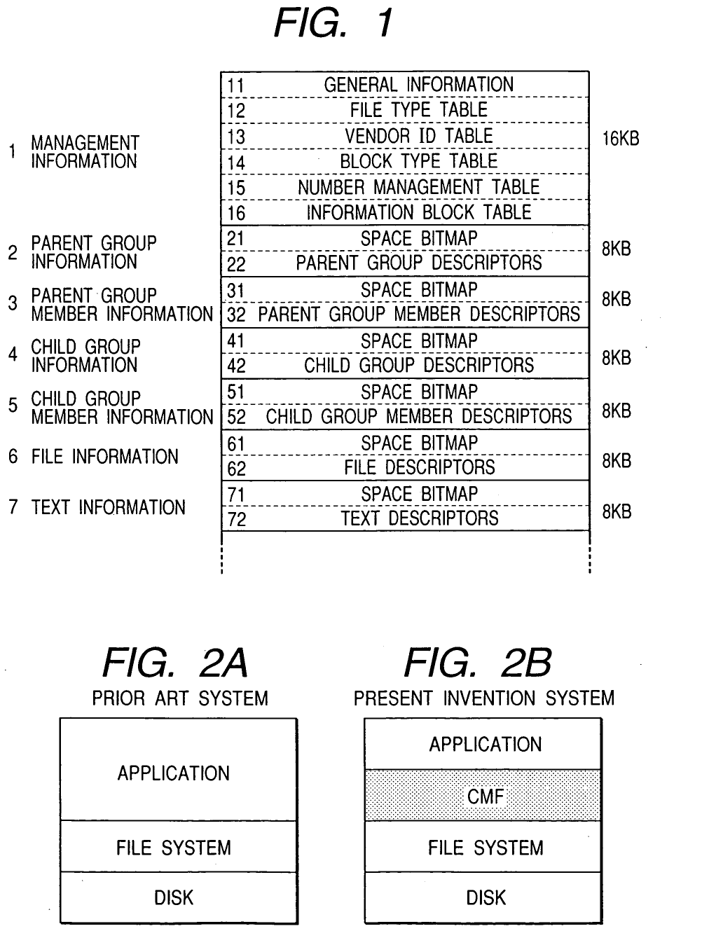

FIG. 1 shows the overall structure of the CMF. The CMF has the structure of combination of one management information (Management Information [1]) having the size of 16 Kbytes and several types of information groups each having the size of 8 Kbytes, and each group of 8 Kbyte information will be referred to as an Information Block. The normal Information Blocks include six types: Parent Group Information [2], Parent Group Member Information [3], Child Group Information [4], Child Group Member Information [5], File Information [6], and Text Information [7], and groups can be created in a two-level hierarchy of Parent Group and Child Group layers. As described hereinafter, there are other Information Blocks: Vendor Specific Information [8] and Dummy Information [9]. The Vendor Specific Information [8] is used for recording of information specific to Vendor and the Dummy Information [9] is used for preliminarily reserving an area. A Space Bitmap for management of space areas in a Block is placed at the top of each Information Block, and includes “1” in data-existing areas and “0” in space areas. At the initial stage there exist space areas in each Information Block, but a new Information Block of 8 KB is added to the tail of the CMF when the Information Blocks become full of data as a result of addition of information. The size of the Information Blocks can be any other size than 8 KB, and the Information Blocks can have their respective sizes different from each other. However, the size of each Information Block should be a quotient of an error correction unit (ECC block) of the recording medium divided by either of the powers of 2 (1, 2, 4, 8, 16, . . . ). Namely, where the ECC blocks are 32 KB, the size of each Information Block can be either of 32 KB, 16 KB, 8 KB, 4 KB, . . . . This permits the top of each Information Block to be always coincident with the top of an ECC block and thus prevents one Information Block from being recorded over two or more ECC blocks.

The Management Information [1] is a portion for management of the entire CMF and consists of General Information [11] storing a record of general information, File Type Table [12] storing a table of types of files, Vendor ID Table [13] storing a table of IDs of Vendors which created or edited the CMF, Block Type Table [14] storing a table of types of Information Blocks, Number Management Table [15] managing the numbers of objects in the respective Information Blocks, and Information Block Table [16] managing the Information Blocks. The Parent Group Information [2] is a portion storing a record of information about parent groups and consists of Space Bitmap [21] for management of space areas and Parent Group Descriptors [22] including description of actual information. The Parent Group Member Information [3] is a portion storing a record of information about child groups included in the parent groups and consists of Space Bitmap [31] for management of space areas and Parent Group Member Descriptors [32] being a table of members. Likewise, the Child Group Information [4] is a portion storing a record of information about child groups and consists of Space Bitmap [41] for management of space areas and Child Group Descriptors [42] storing description of actual information. The Child Group Member Information [5] is a portion storing a record of information about files included in the child groups and consists of Space Bitmap [51] for management of space areas and Child Group Member Descriptors [52] being a table of members. The File Information [6] is a portion storing a record of information of files and consists of Space Bitmap [61] for management of space areas and File Descriptors [62] as file information. The Text Information [7] is a portion storing a record of information of texts and consists of Space Bitmap [71] for management of space areas and Text Descriptors [72] as text information.

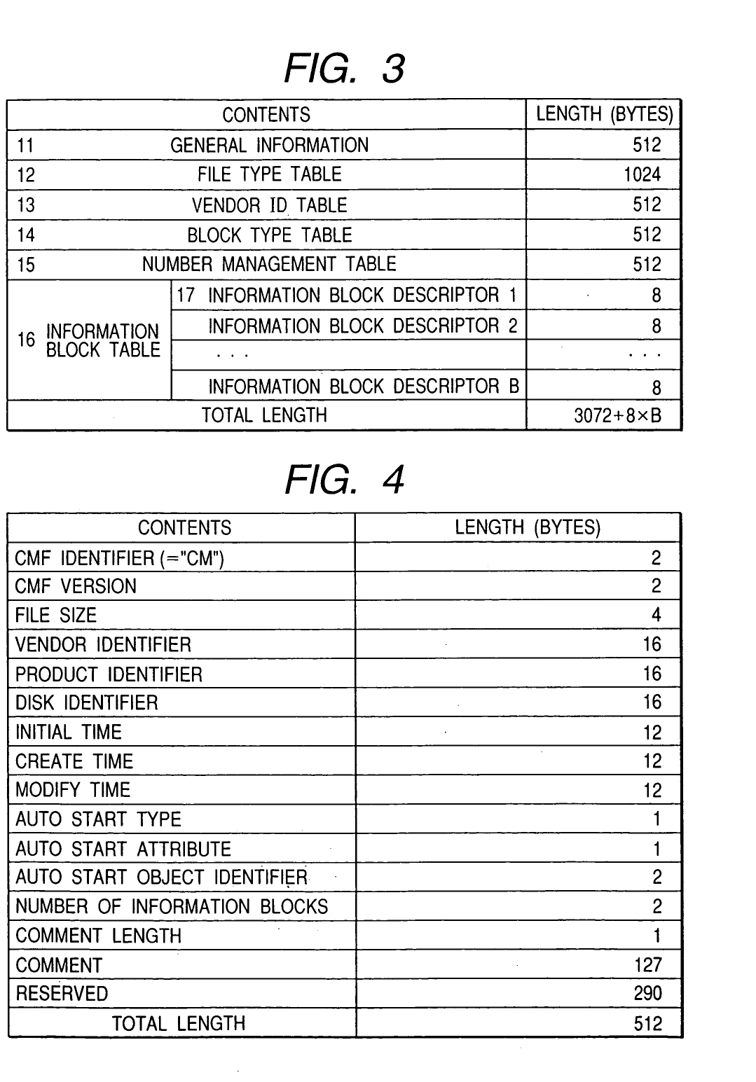

The detailed structure of each of the Information Blocks will be described below. FIG. 3 shows the structure of the Management Information [1] managing the entire CMF. As described above, the Management Information [1] consists of General Information [11], File Type Table [12], Vendor ID Table [13], Block Type Table [14], Number Management Table [15], and Information Block Table [16], wherein the Information Block Table [16] is comprised of Information Block Descriptors [17] corresponding to the respective Information Blocks. Since the recording sequence of the Information Block Descriptors [17] coincides with the recording sequence of the Information Blocks, a recording position of any desired Information Block among the CMF files can be found by referring to the Information Block Table [16]. The data sizes are set as follows: 512 bytes for General Information [11]; 1024 bytes for File Type Table [12]; 512 bytes for Vendor ID Table [13]; 512 bytes for Block Type Table [14]; 512 bytes for Number Management Table [15]; 8 bytes for each Information Block in the Information Block Table [16]. When there are B Information Blocks, the total size is 3072+8×B bytes. Therefore, the maximum number of Information Blocks Descriptors that can be stored in the Management Information Block [1] is 1664.

FIG. 4 shows the structure of the General Information [11] included in the Management Information [1]. This section includes general information such as identification information and dates and times, the number of Information Blocks included in the CMF, a comment, and so on. CMF Identifier stores a record of file identification information at the top of the CMF, and CMF Version is provided for saving identification information about which structure is employed for description in the case of future version of the CMF structure. File Size is the size of the entire CMF and is 64 Kbytes in an initialized state of the disk. Vendor Identifier and Product Identifier are identifiers for identification of CMF creator and creating machine, to which each Vendor can freely allocate character strings. Disk Identifier includes identification information of disk contents, in which a UUID (Universally Unique Identifier) is recorded. Since this information is revised upon initialization of the disk, it is not invariant in each disk. When a copy of the disk is made, the Disk Identifier is also copied as it is. Therefore, the Disk Identifier is not specific to each disk, either. This Disk Identifier can be used to determine whether one of two disks is created as a copy of the other.

Initial Time, Create Time, and Modify Time represent date & time of initialization, date & time of creation of the CMF, and date & time of update of the CMF, respectively, and each information is 12-byte information in the same format as the date & time information of UDF file system. Initial Time and Create Time normally include identical data. For a copy of a disk, however, Initial Time includes information of the original disk but Create Time includes information of date & time of creation of the copy. This means that whether a disk is an original or a copy can be determined by comparing Initial Time with Create Time. When the contents of the disk are modified, the modification is also reflected in the CMF and Modify Time is updated. By comparing Disk Identifiers and Modify Times of two disks with each other, it is thus feasible to determine that the contents of the two disks are identical if they agree.

Auto Start Type, Auto Start Attribute, and Auto Start Object Identifier include automatic start information upon insertion of the disk or upon application of power. Auto Start Type includes types of automatically started data (groups or files), Auto Start Attribute settings about whether automatic start is to be activated, and Auto Start Object Identifier indicates the object ID of group or file numbers of groups and files to be automatically started. Number of Information Blocks stores the number of Information Blocks included in the CMF, Comment Length denotes the length of a comment, and Comment denotes a character string of 127 bytes. The character string is described using the same character code as that used in the file system. Reserved area is provided at the end in such a size that the total size of the General Information becomes 512 bytes.

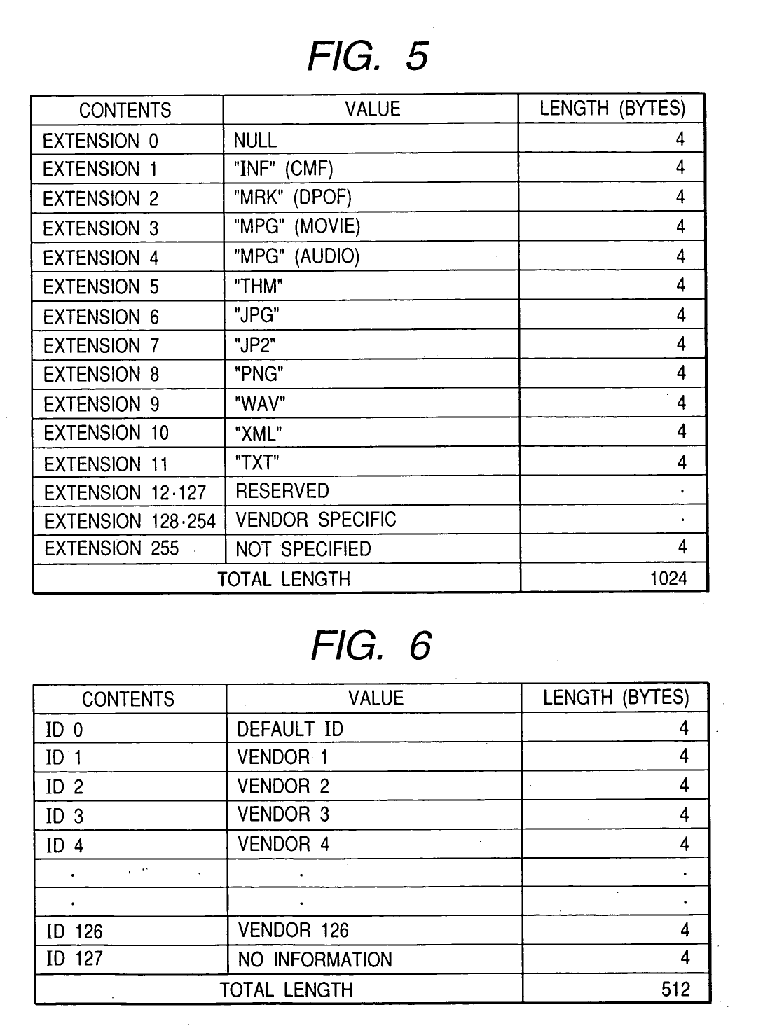

FIG. 5 shows a structural example of the File Type Table [12] included in the Management Information [1]. This table is basically a table of extensions of files, in which different types of files even with the same extension (movie, audio, etc.) are discriminated from each other. For example, in the case of files having the same extension “MPG,” a file including a moving image and audio (Movie) is identified by Type ID=3, and a file including only audio (Audio) is identified by Type ID=4. Each Extension has a storage area of a length of up to four bytes, and an excess area in an extension shorter than four bytes is filled with 0×00. It is possible to register 256 types of extensions in total, and extensions specific to Vendors can be registered in numbers of 128 to 254. Null at the number 0 indicates a file with no extension, and Not Specified at the number 255 an extension not registered in the File Type Table [12]

FIG. 6 shows the structure of the Vendor ID Table [13] included in the Management Information [1], and this table is used for identity of Vendors which created Vendor Specific Information Block. Each Vendor ID has an area of four bytes, among which three bytes are actually used for an ID specific to Vendor (company ID) managed by IEEE, which is used as (first three bytes of) MAC address in network cards of Ethernet or the like, and the remaining one byte is filled with 0×00. It is possible to register 128 IDs in total, but 126 Vendors can be actually registered, because ID=0 is a default ID used for indication of a common Information Type and ID=127 indicates no ID (No Information).

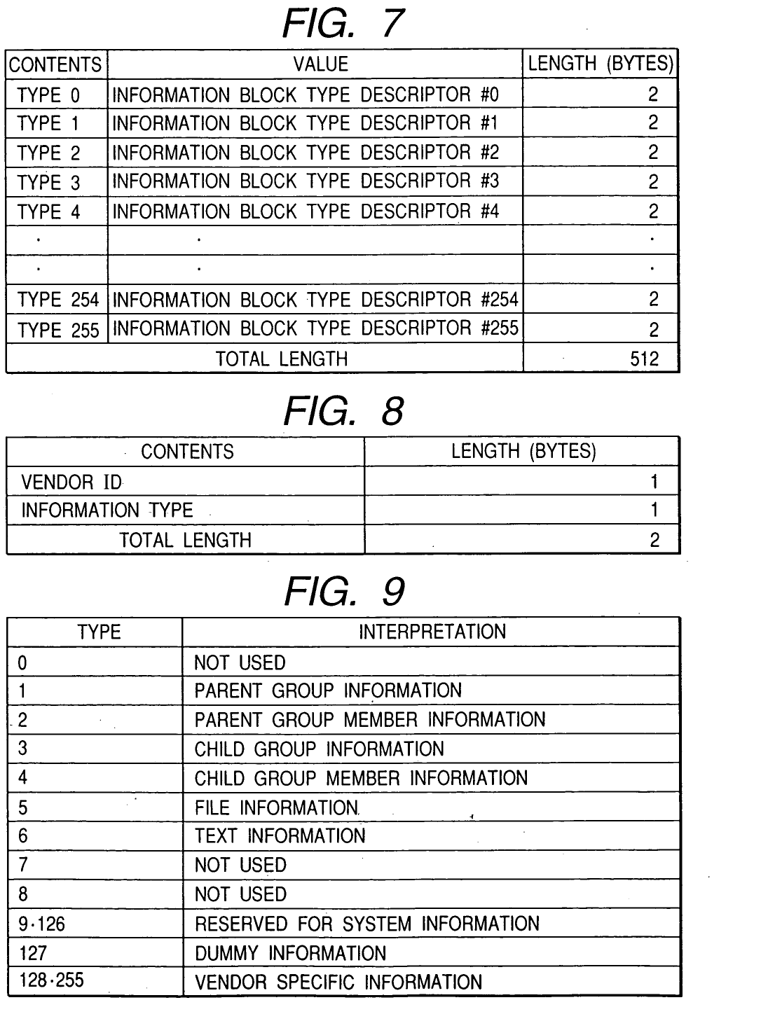

FIG. 7 shows the structure of the Block Type Table [14] included in the Management Information [1], and the table stores a list of types of Information Blocks. It is possible to store 256 Information Block Type Descriptors of two bytes shown in FIG. 8 and each Descriptor designates a combination of a Vendor ID (FIG. 6) with an Information Type (FIG. 9) one byte each. Information Types can be categorized under 256 types, as shown in FIG. 9, among which Types 0 to 127 are used for the system and Types 128 to 255 for users (Vender Specific). Among the Types for the system, Types 0 to 8 (normal object Information) and Type 127 (Dummy Information) are preliminarily specified, and Types 9 to 126 are Reserved. Types 0, 7, and 8 are not used, as reasoned hereinafter. In the Block Type Table (FIG. 7), Types 0 to 8 are predetermined and include the Vendor ID of 0 (Default ID) and the Information Types of 0 to 8. The Block Types 0, 7, and 8 are not used as the Information Types (FIG. 9) are not.

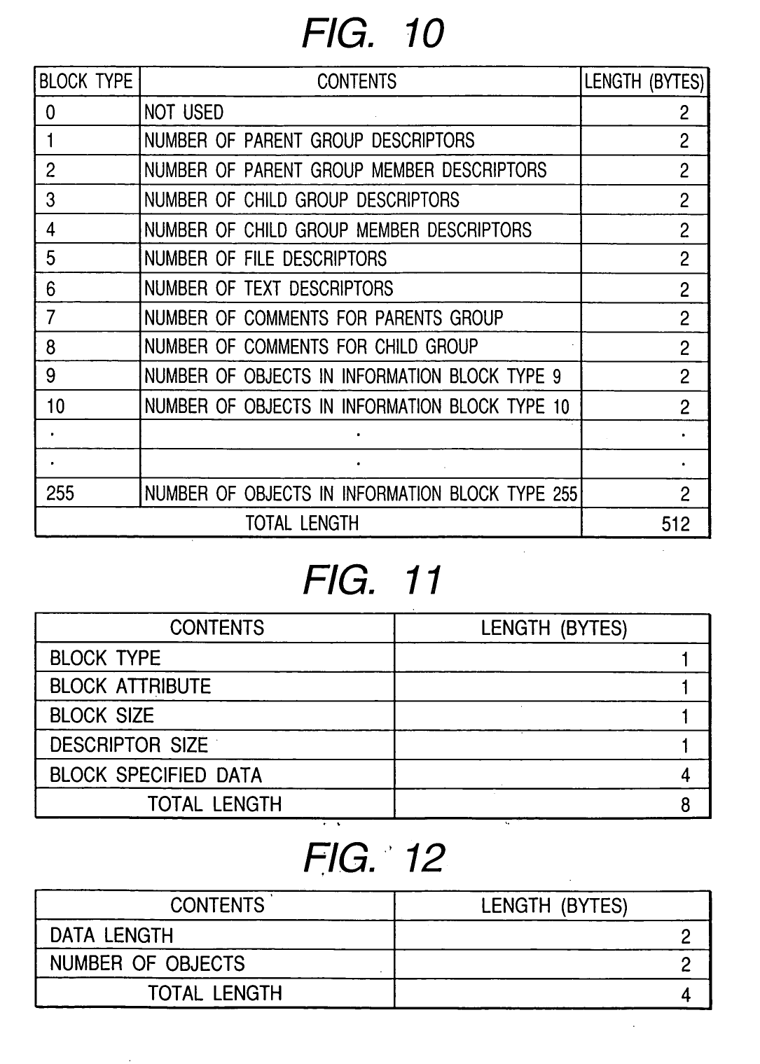

FIG. 10 shows the structure of the Number Management Table [15] included in the Management Information [1], and each Block Type represents the number of all objects included in the corresponding Information Block Type indicated in the Block Type Table [14] (FIG. 7). This is the total number of objects included in all Information Blocks of an identical Information Block Type; for example, where the CMF includes ten File Information Blocks [6], the number of objects in this case is the total number of all files included therein in the ten File Information Blocks. 256 object numbers according to the Information Block Types (FIG. 7) can be stored each in two bytes (or within 65536 objects). Namely, in the case of the Information Block Types 1 to 6, the contents thereof are the number of parent groups, the number of parent group members, the number of child groups, the number of child group members, the number of files, and the number of texts, respectively. The Information Block Type 0 is not used, but portions corresponding to the Information Block Types 7, 8 represent numbers of comments for parent group and for child group, respectively. This is for the purpose of separating the number of comments used for the groups from that used for the others, because the Text Information can include comments of Group Information and others (Vendor Specific Information and others). The number of Text Descriptors used for the other information than the group information can be determined by subtracting the number of comments used for the groups from the total number of texts.

FIG. 11 shows the structure of the Information Block Descriptor [17] which is an element in the Information Block Table [16]. A collection of such Information Block Descriptors [17] constitute the Information Block Table [16]. Block Type indicates the type of the Information Block and includes a value presented in the Block Type Table [14]. Block Attribute indicates attribute information of the Information Block and the contents included therein are different depending upon the types of Information Blocks. For the File Information Block, the Block Attribute contains information about whether each of file information and directory information is included. For the Text Information Block, the Block Attribute contains information about whether each of parent group, child group, and other comment information is included. The Block Attribute also contains attribute information about whether the Space Bitmap is included, which is common to all the Information Blocks.

Block Size indicates the size of the Information Block and is expressed by an integral multiple of 2 KB. In the present embodiment, since all the Information Blocks have the size of 8 Kbytes, the Block Size is 4. Descriptor Size indicates the size of one Descriptor included in the Information Block and, using it, it is possible to calculate a maximum Descriptor number (n) and a top Descriptor position (p) included in the Information Block. (Suppose Block Size=b bytes and Descriptor Size=d bytes)

Maximum Descriptor number: n=int((b×8)/(1+8×d))

Top Descriptor position: p=b−d×n

Block Specified Data indicates information specific to the Information Block and stores information of Data Length and Number of Objects, as shown in FIG. 12, in the case of the System Information Blocks (Information Types 0 to 127). Data Length is an effective data length in the Information Block, which is a length to the last data, regardless of whether there is a space area in the middle of data. Number of Objects is the number of data included in the Information Block and contains the number of Descriptors. Space areas in each Block are managed by the Space Bitmap in each Block and the number of space areas and the data length in each Block are managed by the management Block at the head of the CMF as described above. Therefore, it is feasible to reduce the volume of data resident on the memory and also reduce the amount of search.

Since the number of Objects that can be recorded in each Information Block is fixed for each type, the number of space areas can be calculated by subtracting the Number of Objects from the maximum recordable number. Further, the necessary data length can be calculated by multiplying the Number of Objects by the Descriptor Size, and by comparing it with the Data Length, it is possible to determine whether there is a space area in the middle of data.

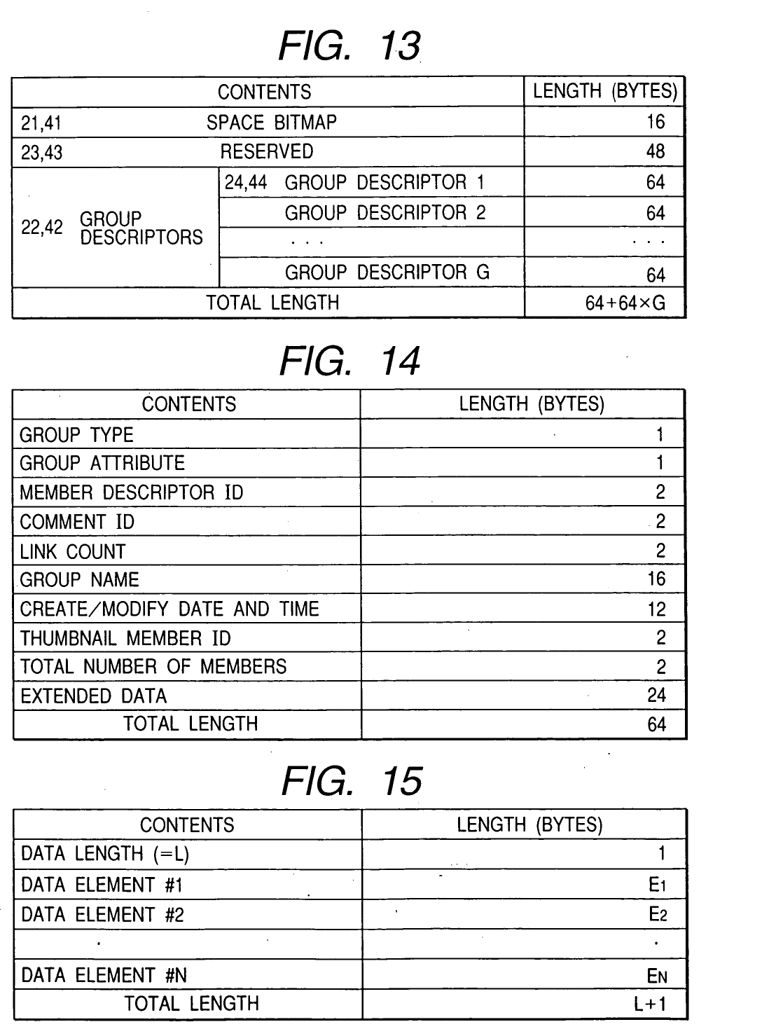

FIG. 13 shows the structure of the Parent Group Information Block [2] and Child Group Information Block [4] storing the record of general information about parent groups and child groups, and the both blocks have the same structure. This is a table of group information of Parent/Child Group Descriptors [24, 44] of 64 byte units (cells) in the Information Block of 8 Kbytes. The collection of the group information [24, 44] is Parent/Child Group Descriptors [22, 42]. Parent/Child Group Descriptor Space Bitmap [21, 41] indicates whether each cell of 64 byte unit stores effective group information. 127 group information pieces [24, 44] can be stored at the maximum in one Information Block, and presence/absence of effective data in each cell is managed in one bit/cell with use of 16 bytes by the Space Bitmap [21, 41]. Namely, effective group information is stored in a cell with a bit indicated by “1” in the Space Bitmap [21, 41] and no effective information is written in a cell with “0.” Therefore, information can be written over the cell with “0.” Reserved area [23, 43] is an excess area from the cell of 64 byte unit in the Space Bitmap [21, 41]. When the number of the group information of Parent/Child Group Descriptors [24, 44] is G, the effective data size is 64+64×G bytes. In the present embodiment the maximum number of Group Descriptors of parent groups and child groups is 16384 in the entire CMF respectively.

FIG. 14 shows the structure of the Group Descriptor [24, 44], and the parent group and child group have the same structure. Group Type includes information about whether the group is a parent group or a child group, and information about whether the group is a user-defined group created by the user or a system group automatically created by the system. In the case of the system group, the type of the group is recorded, whereas in the case of the user-defined group the user can determine the type of the group. In the present embodiment, groups automatically created by the system can include a date group based on a recording sequence and a play list group as a table of files included in a play list. A table of date child groups is a date parent group, and a table of play list child groups is a play list parent group. Since members of a date child group can include all types of files, it is feasible to reproduce a recording sequence, regardless of the types of files, by use of the date group.

Group Attribute includes attribute information of the group, which is information about whether the group is a deleted group, information of a write protected attribute, information about whether a representative thumbnail image is a thumbnail of a group member, information about whether the Group Descriptor includes Extended Data, and so on. Member Descriptor ID is information for specifying a Group Member Descriptor storing a record of members included in the group, and is represented by a recording position thereof in the Group Member Information Block. This is expressed by a serial number of 2 bytes according to the recording sequence of Group Member Descriptors included in the entire CMF. When the number is given, it is feasible to specify the Information Block including the group, and the position thereof in the Information Block. One Group Member Information Block can store information of 127 group members at the maximum. For example, when the Member Descriptor ID is 300, this information indicates information of the forty sixth group member in the third Group Member Information Block. Comment ID indicates a comment added to the group, which is used for display of the group table, search for the group, etc. and the substance of the comment is in the Text Information. The Comment ID is expressed by a serial number of 2 bytes according to the recording sequence of texts, as in the case of the specifying method of Group Member Descriptors, and includes 0×FFFF in the case of no comment.

Link Count represents the number of reference links from a parent group in the case of a child group. When Link Count is 0, the child group does not belong to any parent group. When Link Count of the child group is greater than 1, it has a reference link from either parent group and thus overwriting thereon is prohibited even if it is deleted. Namely, the position of the pertinent child group deleted is kept as a used area (“1”) in the Space Bitmap [21, 41] in the Group Information Block [2, 4] to which the child group deleted belongs. This eliminates a need for revision in the information of the parent group to which the pertinent child group belongs, in the case of the child group being deleted. (Originally, when a child group belonging to a parent group is deleted, the parent group information should be revised, but the revision will take some time, because it is necessary to search for the child group ID of the child group belonging to the parent group.) When the parent group is deleted contrary, each Link Count is decremented by one for the child groups included in the parent group. If a child group with Link Count of 0 at that point is one already deleted, the position of the information of the pertinent child group is set into a space area (“0”) in the Space Bitmap [21, 41] so as to permit overwriting thereon. In the present embodiment, the parent groups are not referenced from the other groups, and thus the value of Link Count is always 0 for the parent groups.

Group Name indicates a name of the group, and the user can freely name the group except for the groups automatically created by the system. In the case of the system groups, a date (YYYY:MM:DD) is recorded in the Group Name for a date group, and a directory number and a file name (nnn:PLAYxxxx) is recorded in the Group Name for a play list group. The Group Name is expressed by unicode (the same character code as that of UDF file system), in which the top one byte is used for identification of the character code and the rest area is filled with 0×00. Create/Modify Date and Time indicates a date and time of creation/update of the group information, which is stored in 12 bytes of the same format as the date and time information of the UDF. Thumbnail Member ID indicates a representative member having a representative thumbnail image used in display of the group table or the like. Without setting of this Thumbnail Member ID (ID=0×FFFF), the top member in the Group Member Descriptor is defined as a representative member. When the group is a child group, the Thumbnail Member ID indicates a file number recorded in the File Descriptor. When the group is a parent group, the Thumbnail Member ID indicates either a child group or a file. Information about which is designated is written in the Group Attribute. An ID of a Child Group Descriptor is given in the case of the child group, while an ID of a File Descriptor in the case of the file. When the representative member of the parent group is a child group, the representative thumbnail is a representative image of the representative child group. Total Number of Members is the total number of members included in all the Group Member Descriptors belonging to this group.

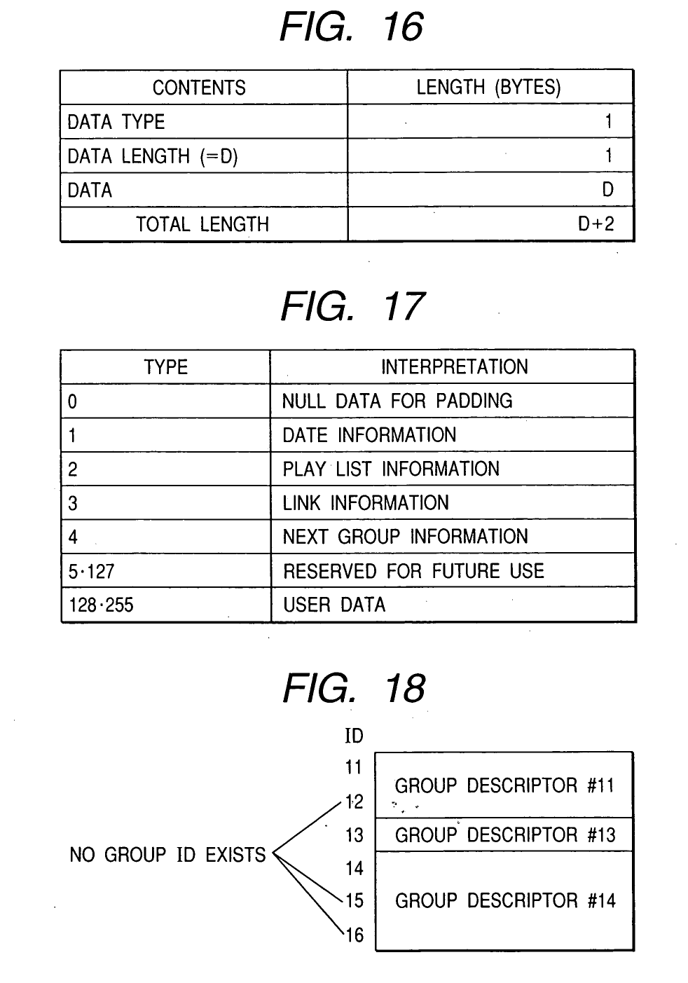

Extended Data is a structure for storage of group information except for the above, and has the structure shown in FIG. 15. A plurality of Data Elements can be stored in the Extended Data and the sum of sizes of all the Data Elements (Data Length) is recorded in the top one byte. FIG. 16 shows the structure of a Data Element. Data Type represents the type of the Data Element, Data Length the size of actual data, and Data the actual data. FIG. 17 shows the Data Type, which can store 256 data types in total, wherein Types 0 to 127 indicate System Data and Types 128 to 225 User Data. Among the System Data the Types 0 to 4 are preliminarily defined, and the following will describe the actual data contents of each Data Type. Null Data (Type 0) is used at the tail of the Extended Data, for padding of an excess area of the Extended Data. Date Information (Type 1) stores a record of a date and time of creation when the type of the group is a date group, and has the same structure as the timestamp of UDF. Play List Information (Type 2) stores a play list file ID when the type of the group is a play list group, and is represented by a File Descriptor ID of the play list file recorded in the File Information. Link Information (Type 3) indicates link information to other Object Descriptor associated with this group, and can store a plurality of Object Descriptors. At this time, each Object Descriptor is indicated by an Information Block Type of one byte (FIG. 7) and a Descriptor ID of two bytes. Next Group Information (Type 4) is used for indicating the next Group Descriptor in the case where there exist a plurality of identical date or play list groups, and is indicated by a Descriptor ID of two bytes. The rest User Data (Type 128 to 255) is reserved for recording user specific information with the Vendor ID (FIG. 6) is recorded in the top one byte. The Extended Data has the size of 24+64×n bytes (n is 0 or higher). If the Extended Data overflows from one Group Descriptor (when n is 1 or higher), the overflowing data is recorded in succession in the next Group Descriptor immediately after. At this time, Group Descriptors storing only Extended Data become missing Group IDs. (FIG. 18 shows an example thereof.)

Since in the present embodiment the size of each Group Descriptor is 64 bytes, only 127 groups can be recorded at the maximum in one Information Block. However, by moving part of information to the Group Member Descriptor, it is feasible to increase the maximum number of Groups that can be stored in one Information Block. For example, in the case where Create/Modify Date and Time and Extended Data are moved to the Group Member Descriptor and the size of the Group Descriptor is decreased to 32 KB, one Information Block can store 255 Groups. Further, where only information of 8 bytes is left, one Information Block can store 1008 groups, whereby it is feasible to increase the number of groups that can be recorded on the memory. If all the information is stored in the Group Member Descriptor, only the Group Member Descriptor ID (2 bytes) remains in the Group Descriptor and it functions as a pointer to indicate the position of the Group Member Descriptor storing all the information about the group.

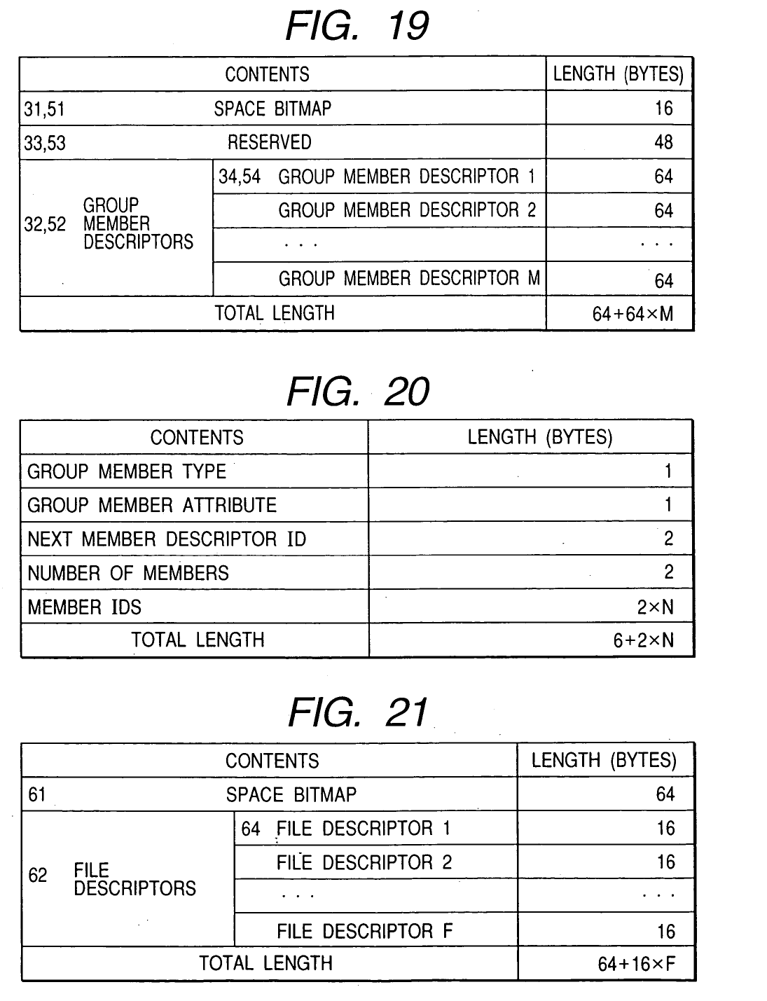

FIG. 19 shows the structure of the Parent Group Member Information Block [3] and Child Group Member Information Block [5] storing the record of the member information of parent groups and child groups. The two Information Blocks have the same structure. This is a table of the group member information of Parent/Child Group Member Descriptors [34, 54] of 64 byte units (cells) in the Information Block of 8 Kbytes, and the collection of the group member information [34, 54] is the Parent/Child Group Member Descriptors [32, 52]. Parent/Child Group Member Descriptor Space Bitmap [31, 51] indicates whether effective group information is stored in each cell of 64 byte unit. One Information Block can store 127 group member information pieces [34, 54] at the maximum, and the Space Bitmap [31, 51] manages presence/absence of effective data in each cell in one bit/cell through the use of 16 bytes. Namely, effective group member information is stored in a cell with a bit represented by “1” in the Space Bitmap [31, 51], and a cell with a bit indicated by “0” includes no effective information and permits overwriting thereon. Reserved area [33, 53] is an excess area from the cell of 64 byte unit in the Space Bitmap [31, 51]. When the number of the group member information of Parent/Child Group Member Descriptors [34, 54] is M, the effective data size is 64+64×M bytes. In the present embodiment 16384 Member Descriptors each for the parent group members and for the child group members can be recorded at the maximum in the entire CMF.

Since the Group Member Descriptor [34, 54] stores a table of members (child groups or files) included in the group, the size of the Descriptor varies depending upon the number of members included. Therefore, in order to facilitate an edit of the group member information, the recording units are fixed as 64 bytes, and in the case of a large number of members, the information is recorded over a plurality of Group Member Descriptors. In the present embodiment, since a block of group member information is included in a single Group Member Information Block, the maximum number of Group Member Descriptors [34, 54] continuously used is 127. In the present embodiment, each parent group includes only child groups, each child group includes only files, and each file for management of plural files (grouping file) such as a play list, a DPOF for management of printing, or the like is also handled as a child group.

FIG. 20 shows the structure of the Group Member Descriptor [34, 54], and the Parent Group Member Descriptor and the Child Group Member Descriptor have the same structure. Group Member Type and Group Member Attribute include the same contents as those of the Group Descriptor to which the Group Member Descriptor belongs. Next Member Descriptor ID indicates the next Group Member Descriptor used when group members overflow from one Group Member Descriptor, and is represented by a recording position thereof in the Group Member Information Block. This is expressed by a serial number of two bytes according to the recording sequence of the Group Member Descriptors included in the entire CMF. When there is no Next Member Descriptor (in the case of the last Group Member Descriptor), the Next Member Descriptor ID includes 0×FFFF. Number of Members indicates the number of members included in this Group Member Descriptor [34, 54], and Member IDs includes a table of the members. One Group Member Descriptor (64 bytes) can store twenty nine members at the maximum. If a collective group includes a large number of members, two or more Group Member Descriptors [34, 54] are connected to store the members. In the case where all the Group Member Descriptors belonging to a single group must be included in a single Group Member Information Block [3, 5], the maximum number of members included in one group is 3683. The specifying method of Member IDs is the same as the specifying method of Next Member Descriptor ID. A child group ID is specified by a number (2 bytes) according to an order of the Child Group Descriptor [44] recorded in the Child Group Information [4], and a file ID is specified by a number (2 bytes) according to an order of the File Descriptor [64] recorded in the File Information [6].

If part of the group information is recorded in the Group Member Descriptor in order to decrease the size of the Group Descriptor, the moved information will be stored in the first Group Member Descriptor. Namely, the first Group Member Descriptor includes both the information moved from the Group Descriptor and the information to be originally recorded in the Group Member Descriptor. In this case, however, since the size of the Group Member Descriptor is 64 bytes, the number of members (N) included in Member IDs becomes smaller. If the table of group members overflows from the first Group Member Descriptor, the rest will be recorded in a new Group Member Descriptor. The second and subsequent Group Member Descriptors have the normal structure (FIG. 20).

FIG. 21 shows the structure of the File Information [6] storing the record of information of files. This is a table of file/directory information of File Descriptors [64] of 16 byte units (cells) in the Information Block of 8 Kbytes, in which the collection of File Descriptors [64] is File Descriptors [62] and File Descriptor Space Bitmap [61] indicates whether each cell of 16 byte unit stores effective file/directory information. One Information Block can store 508 File Descriptors [64] at the maximum, and the Space Bitmap [61] manages presence/absence of effective data in each cell in one bit/cell through the use of 64 bytes. Namely, a cell with a bit indicated by “1” in the Space Bitmap [61] stores an effective File Descriptor, and a cell with a bit indicated by “0” includes no effective information and permits overwriting thereon. When the number of File Descriptors [64] is F, the effective data size is 64+16×F bytes. 65534 file/directory information can be recorded at the maximum in the entire CMF.

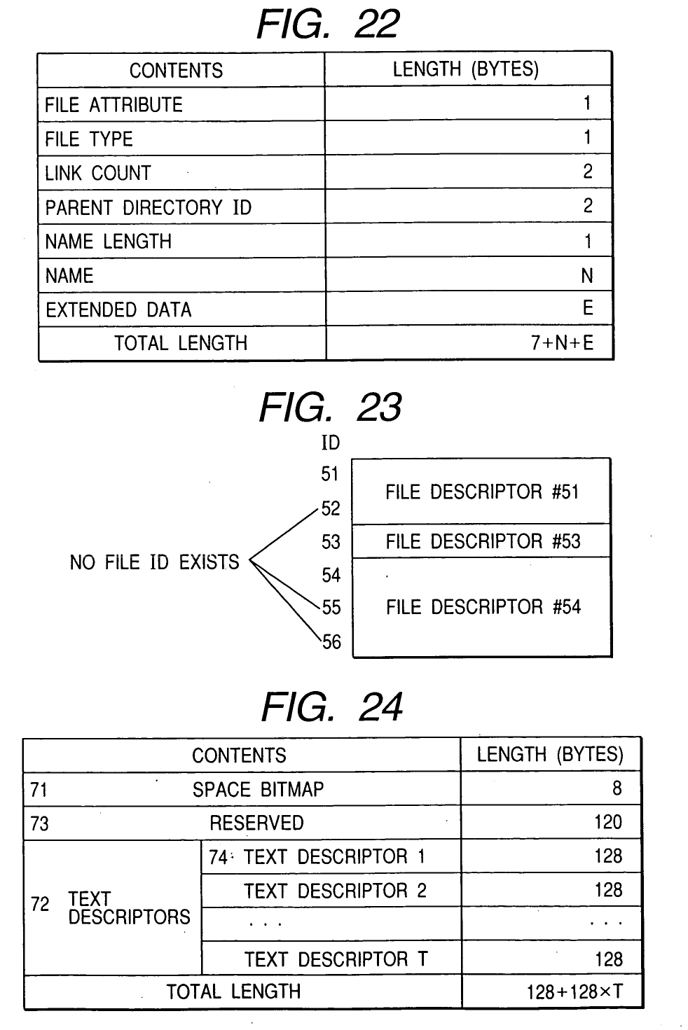

FIG. 22 shows the structure of the File Descriptor [64] as file and directory information. File Attribute indicates attribute information of a file or a directory, includes information about whether a file or a directory, information about whether a deleted file or not, information about the write protected attribute, etc., and, in addition thereto, also includes information about subsidiary file attributes, such as after-recording audio, video for transition, and a text for explanation, information about whether the File Descriptor includes Extended Data, and so on. File Type indicates a type of a file such as a movie, a still image, audio, or a play list, and presents a number of one byte selected from the table indicated by the File Type Table [12] (FIG. 5). This makes it feasible to specify an extension of the file as well. For a directory, the File Type indicates Null (“0”). Link Count is the number of reference links to the file from child groups, and the Link Count of 0 indicates that the file does not belong to any child group. When the Link Count of the file is greater than 1, the file is referenced from either child group and thus overwriting thereon is prohibited even if the file is deleted. Namely, the position of the pertinent deleted file is kept as a used area (“1”) in the Space Bitmap [61] in the File Information Block [6] to which the file to be deleted belongs. This eliminates a need for revision in the information of the child group to which the pertinent file belongs, when the file is deleted. (Originally, if a file belonging to a child group is deleted, the child group information should be revised, but the revision will take some time, because it is necessary to search for the file ID of the file belonging to the child group.) When the child group is deleted contrary, the Link Counts of the files included in the child group are reduced each by one. If a file with the Link Count of 0 at that point is one already deleted, the position of the information of the pertinent file will be set as a space area (“0”) in the Space Bitmap [61] so as to permit overwriting thereon. When the File Descriptor is directory information, the Link Count is always 0.

Parent Directory ID indicates a File ID of the parent directory and designates a number (2 bytes) according to an order of the directory information of the File Descriptor [64] recorded in the File Information [6]. Name Length and Name indicate the length and the actual name of the file or directory, respectively, and Name is expressed by unicode (the same character code as that of UDP file system). The top one byte of the Name area is an identifier of the character code and includes 0×08 in the case of 8 bits per character or 0×10 in the case of 16 bits per character. Name Length is the byte length also including the character code identifier and the Name cell can store a name without an extension in the size of up to 255 bytes at the maximum. Extended Data has the same structure as the Extended Data of the group information (FIG. 15, FIG. 16, and FIG. 17). Since the Name and Extended Data have variable lengths, when the size of the File Descriptor [64] is greater than 16 bytes (N+E is not less than 10 bytes), the data is continuously recorded in the next File Descriptor immediately after, and the size of the Extended Data is adjusted so that one File Descriptor becomes an integral multiple of 16 bytes. At this time, each File Descriptor area used for recording of File Name and Extended Data is set as a used area (“1”) in the Space Bitmap [61] of the File Information [6], and a File ID specified by that position is a missing File ID. (FIG. 23 shows an example thereof.)

In the present embodiment a real character string is stored as each file name, but it is also possible to express each directory name or file name by a numeral of 2 bytes, thereby decreasing the size of the File Descriptors to a value smaller than 16 bytes. Specifically, in the File Descriptor (FIG. 22), the Name Length and Name are replaced by a value of 2 bytes (Name ID) to decrease the size of the File Descriptor to 8 bytes. As shown in the directory structure of FIG. 26, the present embodiment is configured so that the names of the directories including movies, still images, audio, play lists, etc. are expressed by the three-digit numbers as top three characters and the numbers do not overlap each other among the names of the directories including the same type of files. For this reason, a directory can be uniquely determined by specifying a type of files by File Type and specifying a directory number as a directory name. As for the file names, four-digit numbers included in the file names do not overlap each other among the same type of files in one directory, as in the case of the directory names. Namely, since an extension is given by File Type, a file can be uniquely determined by specifying a number of the file at the file name. In this configuration, the number of File Descriptors included in one Information Block is 1008, whereby information of more files can be stored on the memory.

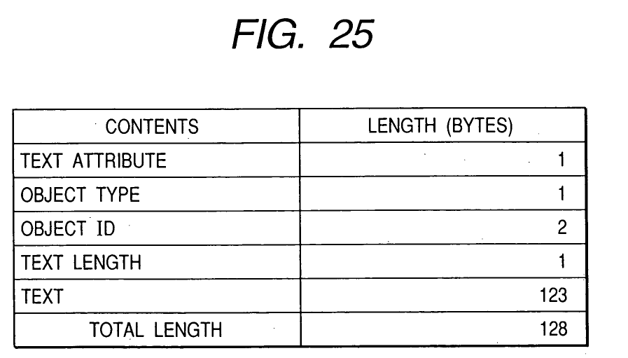

FIG. 24 shows the structure of the Text Information [7] storing the record of text information used for the comments of groups and for the comments specific to the Vendors. This is a table of text information of Text Descriptors [74] of 128 byte units (cells) in the Information Block of 8 Kbytes, in which the collection of the text information [74] is Text Descriptors [72] and in which Text Descriptor Space Bitmap [71] indicates whether effective text information is stored in each cell of 128 byte unit. One Information Block can store 63 text information [74] at the maximum, and the Space Bitmap [71] manages presence/absence of effective data in each cell in one bit/cell through the use of 8 bytes. Namely, effective text information is stored in each cell with a bit indicated by “1” in the Space Bitmap [71], and no effective information is written in each cell with a bit indicated by “0.” Reserved area [73] is an excess area from the cell of 128 byte unit of the Space Bitmap [71]. When the number of the text information of Text Descriptors [74] is T, the effective data size is 128+128×T bytes.

The Management Information [1] can store 1664 Information Block Descriptors at the maximum, among which each of Parent Group Information [2], Parent Group Member Information [3], Child Group Information [4], Child Group Member Information [5], and File Information [6] uses 130 Blocks at the maximum. Since it is necessary to obtain 521 Blocks of the Text Information [7] for the comments of parent groups and child groups, the user is allowed to freely use 493 Blocks in total of the Text Information [7] and Vendor Specific Information [8].

FIG. 25 shows the structure of the Text Descriptor [64] as text information. Text Attribute is attribute information of the text and includes information about whether the text is one deleted, information about the write protected attribute, and so on. Object Type includes a type of information (Object) referencing the Text Descriptor and is indicated by the Type value of the Block Type Table [14] (FIG. 7). Object ID specifies a number of 2 bytes according to an order of the Object Descriptor (Group Descriptor or the like) recorded in the Object Information (Group Information or the like). The Object Type and Object ID enable reverse reference to the information (a group or the like) referencing the text. Text Length includes the record of the length of a character string, and in the area a real character string is recorded by UTF-8 or UTF-16 (the same character code as that of the file system). The top one byte of the Text area is an identifier of the character code and includes 0×08 in the case of UTF-8 or 0×10 in the case of UTF-16. The Text Length is a byte length also including the character code identifier, and the Text area can store data up to 123 bytes at the maximum.

2. Operation Procedure with CMF

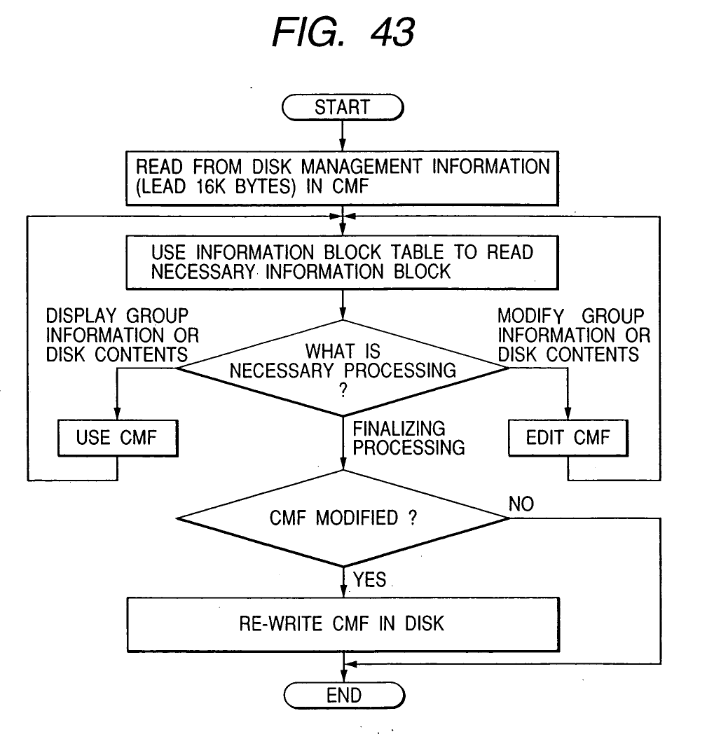

The following will describe the procedure of file management with the CMF, with reference to FIG. 43. FIG. 43 shows the processing from the time of application of power or insertion of the disk to the time of interruption of power or ejection of the disk. The total size of the CMF is variable, but all the information is included in the Information Blocks of 8 Kbyte units which are managed on the basis of the Management Information of 16 Kbytes at the top of the CMF. Therefore, the overall structure of the CMF can be known by reading the Management Information. For this reason, the Management Information is first read from the disk at the time of application of power or insertion of the disk. After that, the applications take in necessary Information Blocks on the basis of the Management Information from the disk as occasion arises. However, the system may also be configured so that the group information, group member information, file information, and text information of 48 Kbytes configured at the time of initialization of the disk is first read together with the Management Information.

At the next step of display of a list of groups or files, the application provides desired display on the basis of the Management Information thus read. The display form depends upon setting on the application side and will be detailed hereinafter. When the contents of the disk are revised or when the group information is provided with additional information or edited, the contents of the CMF are edited. At this time the grouping methods include two types of grouping, grouping according to user's instructions and grouping automatically performed according to dates or the like by the system. In either case, when a necessary Information Block is absent on the memory, it is necessary to perform an operation of reading the Information Block from the disk by making use of the Information Block Table in the Management Information. At the time of interruption of power or ejection of the disk after completion of sequential processing, the CMF is updated if the contents of the CMF file have been modified, and then the updated CMF is written back into the disk. The timing of writing the CMF back into the disk can be set at a time except for the time of the termination process.

3. Display Examples Using Information of CMF

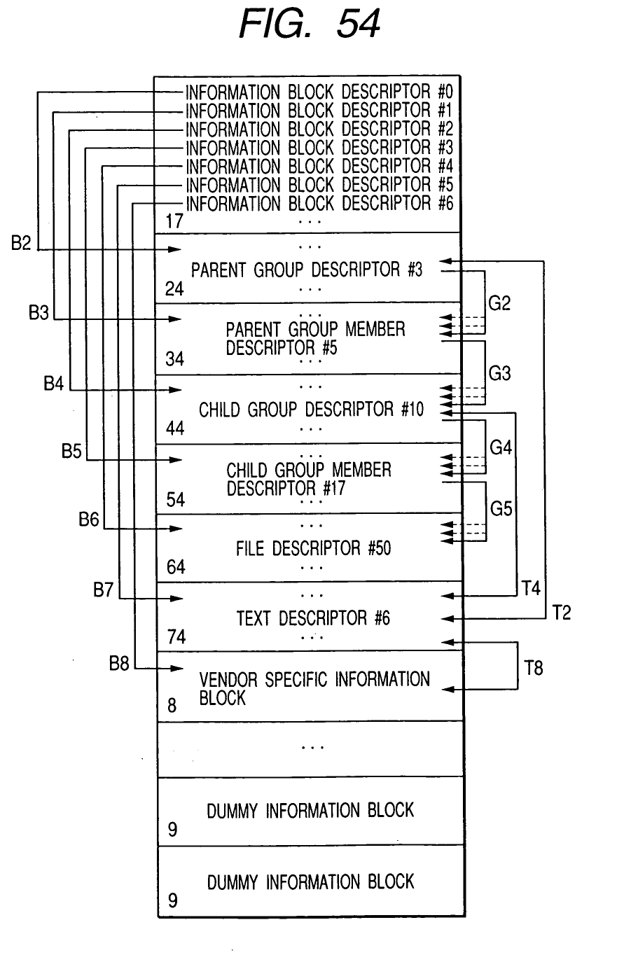

The following will describe an example of the procedure of referencing groups and files through the use of the CMF. FIG. 54 shows an example of the overall structure of the CMF. First, the Information Block Descriptors [17] point to respective Information Blocks included in the CMF [B2 to B8] and manage the information of positions, types, contents, and so on. The Parent Group Descriptor [24] points to the Parent Group Member Descriptor [34] being a table of members included in its own group [G2], and the Parent Group Member Descriptor [34] points to the Child Group Descriptor [44] being members of the group [G3]. The Child Group Descriptor [44] points to the Child Group Member Descriptor [54] being a table of members included in its own group [G4], and the Child Group Member Descriptor [54] points to the File Descriptor [64] being members of the group [G5]. In this example there is no information indicating a reverse direction, each parent group includes only child groups, and each child group includes only files. The Text Descriptor [74] is referenced by Parent Group Descriptor [24], Child Group Descriptor [44], and Vendor Specific Information Block [8] [T2, T4, T8], and is also linked in both ways, because the Text Descriptor [74] itself has the referencing Descriptor information. Dummy Information Blocks [9] at the tail of the CMF are dummy Blocks of 8 KB added in order to make the size of the CMF equal to an integral multiple of the ECC block (e.g., 32 KB). This is for the purpose of preventing other data from being recorded in the ECC blocks containing the CMF, and a Dummy Information Block is replaced by an Information Block on the occasion of adding the Information Block at the tail of the CMF. When the top of each Information Block is arranged at the top of the ECC block, each Information Block is prevented from being recorded over a plurality of ECC blocks and updating and addition of Information Block can be performed efficiently.

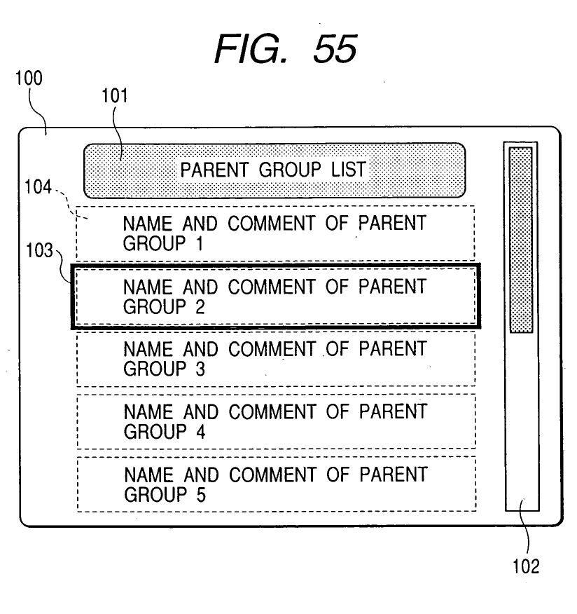

For example, for displaying the group list as shown in FIG. 55, an application first checks the Information Block Descriptors [17] in the Management Information preliminarily read, to extract Information Block Descriptors [17] whose Block Type is Group Information. Since the recording sequence of the Information Block Descriptors [17] directly indicates the recording positions of the pertinent blocks [2, 3, 4, 5, 6, 7, . . . ], the application converts their recording orders into addresses and makes access to associated Group Information [2, 4]. Then the application extracts names, comments, etc. from the Group Descriptor [24, 44] included in the Group Information [2, 4] and displays necessary items on the display. However, the comments are recorded in the Text Information Block [7] and the Group Descriptor [24, 44] includes only text IDs indicating the comments. For this reason, the application needs to refer to the Information Block Descriptor [17] and access the Text Information Block [7] of the objective text IDs to read the Text Descriptor [74]. Since the Text Descriptor [74] includes the reverse reference information to the Group Descriptor [24, 44] referencing itself, it is easy to search for the comments through the use of the reverse reference information to retrieve the group information including the comments.

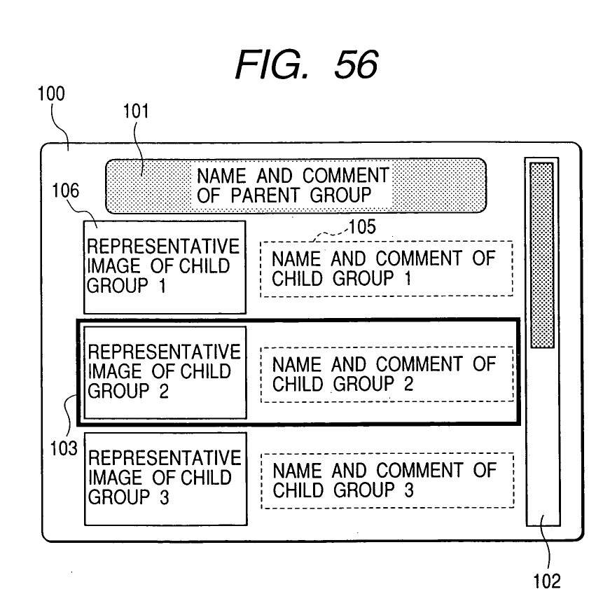

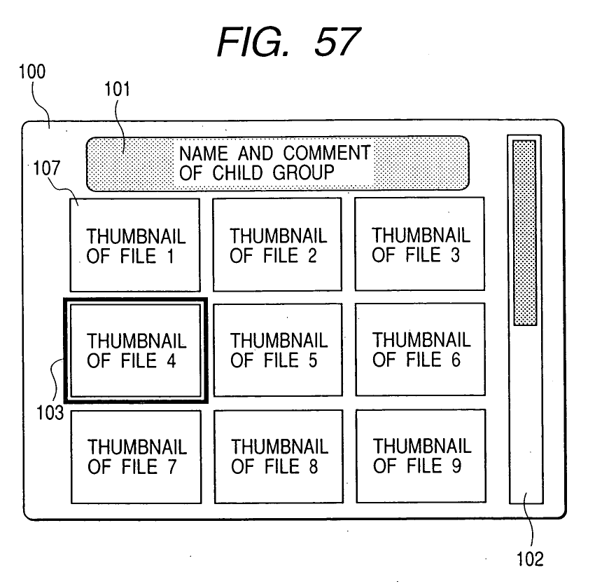

Other display forms will be described below with reference to FIG. 56 and FIG. 57. In FIG. 55, the title of the window [101] and the comments of parent groups [104] are listed on the display [100] and the display area is represented by a scroll bar [102]. When a parent group in a frame [103] is selected, a list of child groups belonging to the parent group thus designated are displayed as shown in FIG. 56. This is implemented so that the application acquires a group ID of the included child groups from the Parent Group Member Descriptor [34] associated with the selected parent group, accesses the Child Group Descriptor [44] on the basis of the group ID, and displays a list of child groups belonging to the selected parent group. At this time, since entities of representative images and comments are not included in the Child Group Descriptor [44], the application needs to access the objective File Descriptor [64] and Text Descriptor [74] on the basis of Thumbnail IDs and Comment IDs and read the entities. During this display, when a child group deleted is found, the Link Count of the child group is decremented by one. If the Link Count reaches 0, the value at the pertinent portion is changed to “0” (overwritable) in the Space Bitmap of the Information Block to which the child group belongs, the Number of Objects is decremented by one in the Information Block Descriptor, and the Data Length is also decreased if necessary.

In the display example of FIG. 56, the title of the window [101], and representative images [106] and comments [105] of child groups are arranged on the display [100], and the display area is represented by the scroll bar [102]. The thumbnails of the child groups are thumbnails of representative files indicated by the Thumbnail IDs and, for a child group without designation of a representative file, a representative member of the child group is defined as a top file in a list of files included in the child group. A child group selected is enclosed in a frame [103]. When a decision is made in this state, a list of files belonging to the child group designated is displayed, or the files are successively reproduced. On the occasion of successively reproducing the files, files with subsidiary attributes may be skipped without being reproduced. If the child group is a play list group, the play list is reproduced. During the display of the list of files or during the sequential reproduction, when a file deleted is found, the Link Count of the file is decremented by one. If the Link Count reaches 0, the value at the pertinent portion is changed to “0” (overwritable) in the Space Bitmap of the Information Block to which the file belongs, the Number of Objects is decremented by one in the Information Block Descriptor, and the Data Length is also decreased if necessary.

FIG. 57 shows a display example of a list of files belonging to a selected child group. The information necessary for the display is acquired according to the procedure similar to the above, and only thumbnail images are displayed in this example. The title of the window [101] and the thumbnail images of the files [107] are arranged on the display [100], and the display area is represented by the scroll bar [102]. A selected file is enclosed in a frame [103]. When a decision is made in this state, the file designated is reproduced. If the file is a still image, the still image is displayed. If the file is a movie, reproduction of the movie is started. A file with an subsidiary attribute does not always have to be displayed in the list.

The above presented the three types of display examples, but it is noted that the display methods of the parent groups, child groups, and files are not limited to the above display examples; for example, the display of parent groups may also include simultaneous display of thumbnails and comments of representative child groups, or only comments may be used for the display of the file list.

4. Updating Procedure of CMF

The following will describe the procedure of updating the contents of the CMF. First, changes in the data structure of the CMF due to updating will be described according to respective situations.

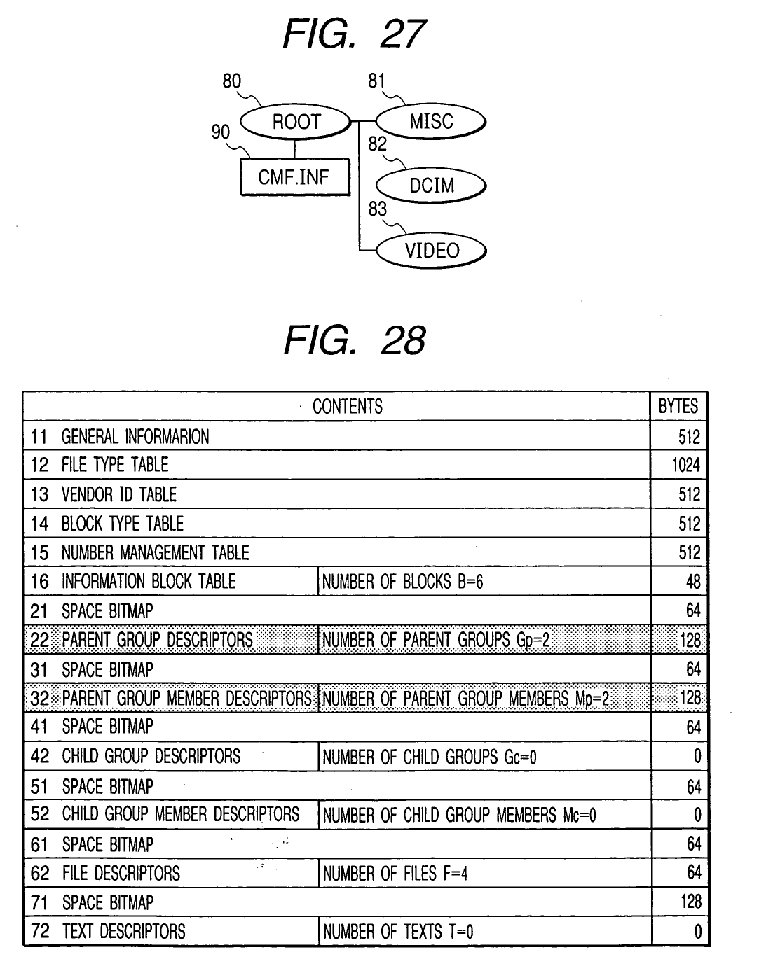

FIG. 27 shows the directory structure at the time of initialization of the disk and FIG. 28 the CMF structure at that time. In the initialized state, there are only directories of ROOT [80], MISC [81], DCIM [82], and VIDEO [83] and there exists no file. The CMF is comprised of one Management Information of 16 Kbytes and six Information Blocks of 8 KB each, and includes four directory information pieces and two group information pieces. Since the present embodiment is configured to have the date group and the play list group as defaults, their parent groups, i.e., Parent Group Descriptors [22] and corresponding Parent Group Member Descriptors [32] are first created two each. At this time the Parent Group Member Descriptors [32] include no member. Since there are four directories, four File Descriptors [62] of directory information are created. In the Space Bitmaps of these Information Blocks, “1” is set at bits corresponding to positions of the Object Descriptors with entry of the data. There is no data in the child group information [42, 52] and in the text information [72]. The Information Block Table [16] includes the information about the six Blocks except for the Management Information [1]. Since the Reserved area in each Information Block is included in the Space Bitmap area, the illustration does not show them.

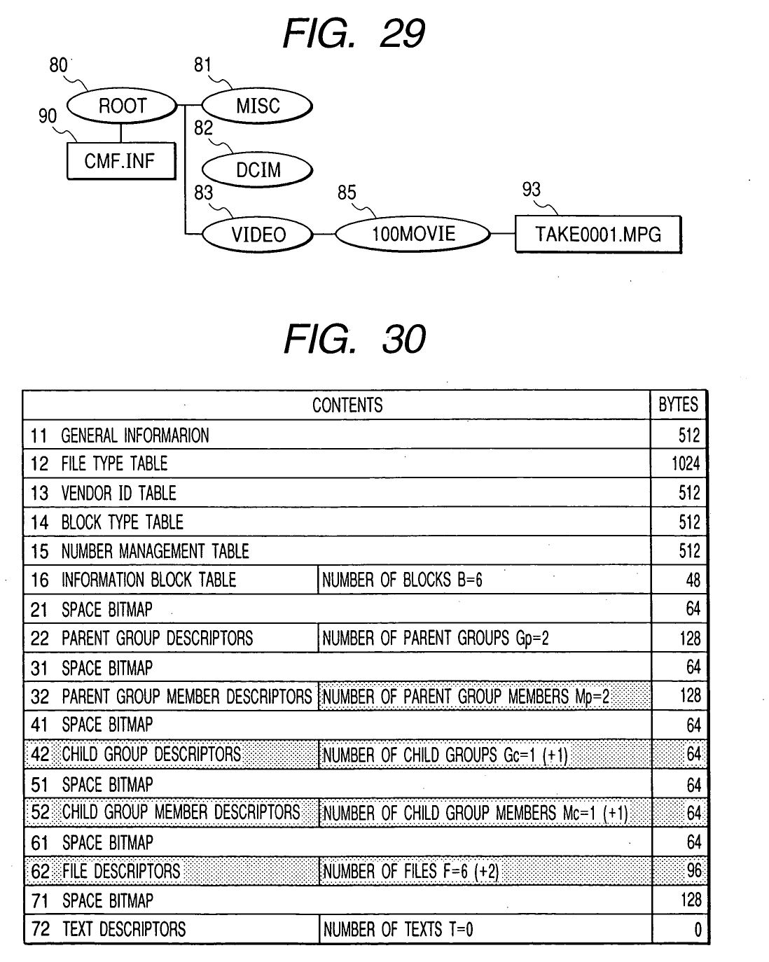

FIG. 29 shows the directory structure with only one movie file (TAKE0001.MPG) [93] recorded immediately after the initialization. A movie directory (100MOVIE) [85] is automatically created under the VIDEO directory [83] and the movie file is recorded under this movie directory. FIG. 30 shows the CMF structure at this time. When compared with FIG. 28, a directory information piece and a file information piece are added one each to the File Descriptors [62] in the File Information [6]. When the file is added, it is automatically registered in the date group, so that the Child Group Descriptor [42] of the date child group and the Child Group Member Descriptor [52] as a member thereof are automatically created one each. The new file created is registered as a member of the Date Child Group Member Descriptor [52], and the Date Child Group Descriptor [42] created this time is also registered as a member of the Date Parent Group Member Descriptor [32]. At this time, bits corresponding to the recording positions are changed from “0” to “1” in the Space Bitmaps of the Information Blocks to which the Descriptors were added, and the information in the Information Block Table [16] is also updated simultaneously.

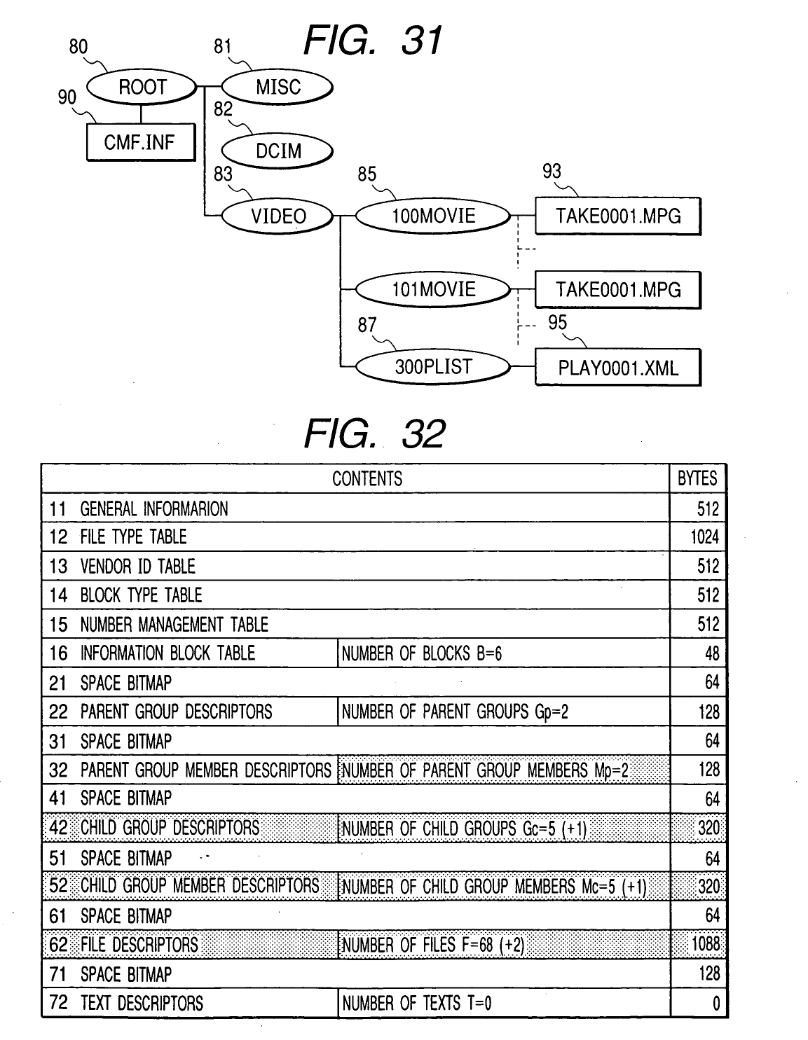

FIG. 31 shows the directory structure wherein a new play list file (PLAY0001.XML) [95] is added in a recording state of two movie directories [85] and sixty movie files [93]. Since in this example the sixty files are separately recorded under two directories, there are two movie directories [85] made. When a new play list file [95] is created, a play list directory (300PLIST) [87] is automatically created under the VIDEO directory [83] and the play list file is recorded under this play list directory. FIG. 32 shows the CMF structure at this time, in which the number of File Descriptors [62] is 68, because the directory and file are incremented by one each to count 68 in total. If a further play list file is added, it will be automatically registered in the play list group to result in automatically creating the Child Group Descriptor [42] of the play list child group and the Child Group Member Descriptor [52] of the member thereof one each. The new play list file is registered as a member of the Play List Child Group Member Descriptor [52], and the Play List Child Group Descriptor [42] created this time is also registered as a member of the Play List Parent Group Member Descriptor [32] of the play list group. At this time, bits corresponding to the recording positions are changed from “0” to “1” in the Space Bitmaps of the Information Blocks to which the Descriptors were added, and the information in the Information Block Table [16] is also updated simultaneously.

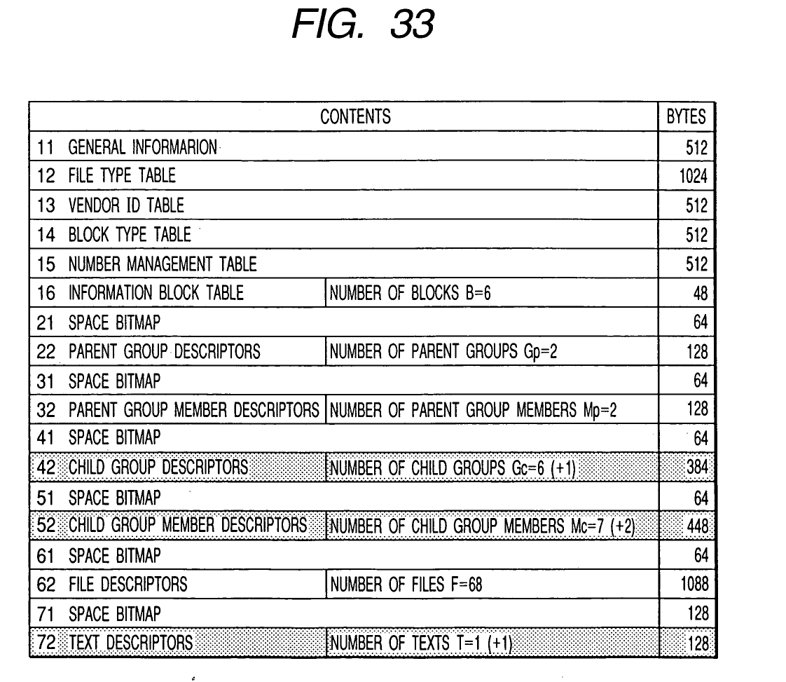

FIG. 33 shows the CMF structure wherein a child group with a comment including thirty or more files is added, with respected to the state of FIG. 32. On the occasion of grouping except for a grouping file such as a play list or the like, no actual file is created and the directory structure is the one as shown in FIG. 31. Since a child group with 30 or more files (below 59 files) necessitates two Child Group Member Descriptors [52], the number of child group members in the Child Group Member Descriptors [52] is incremented by two and one Child Group Descriptor [42] having a reference link thereto is added. Only one Group Descriptor [42] is added for one group, independent of the number of Group Member Descriptors [52] used by the group of one block. Since the comment is recorded in the Text Information [7], one Text Descriptor [72] is added. For the above modifications at the three portions, the information is updated in the Space Bitmaps [41, 51, 71] of the corresponding Information Blocks and in the Information Block Table [16].

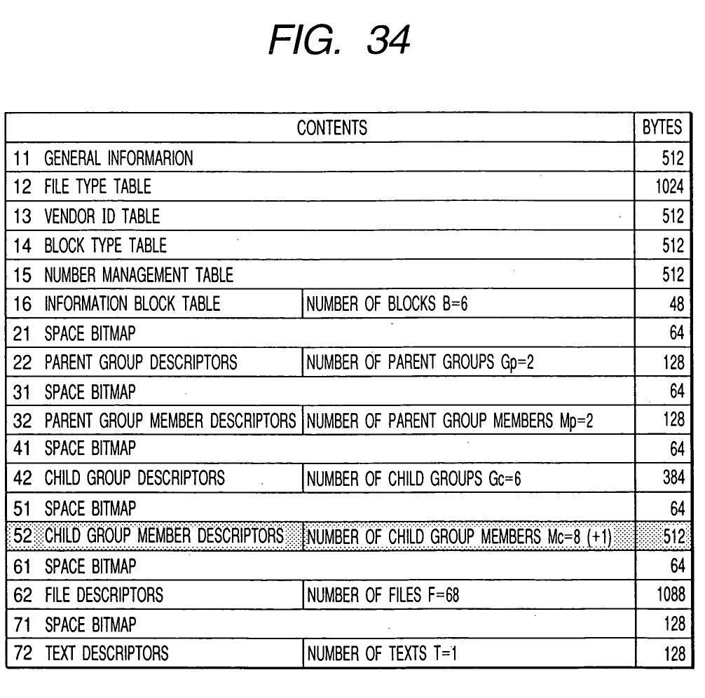

FIG. 34 shows the CMF structure wherein a member is added to a child group and a new Child Group Member Descriptor [52] is created, with respect to the state of FIG. 33. For adding a member to a group, the member can be placed in a space of an existing Group Member Descriptor if present. However, if there is no space a new Group Member Descriptor has to be created. In this example one Child Group Member Descriptor [52] is added. At the same time as it, it is also necessary to update the Next Member Descriptor ID of the Child Group Member Descriptor [52] ahead of the new Child Group Member Descriptor [52]. In conjunction therewith, the information is updated in the Space Bitmap [51] of the corresponding Information Block and in the Information Block Table [16].

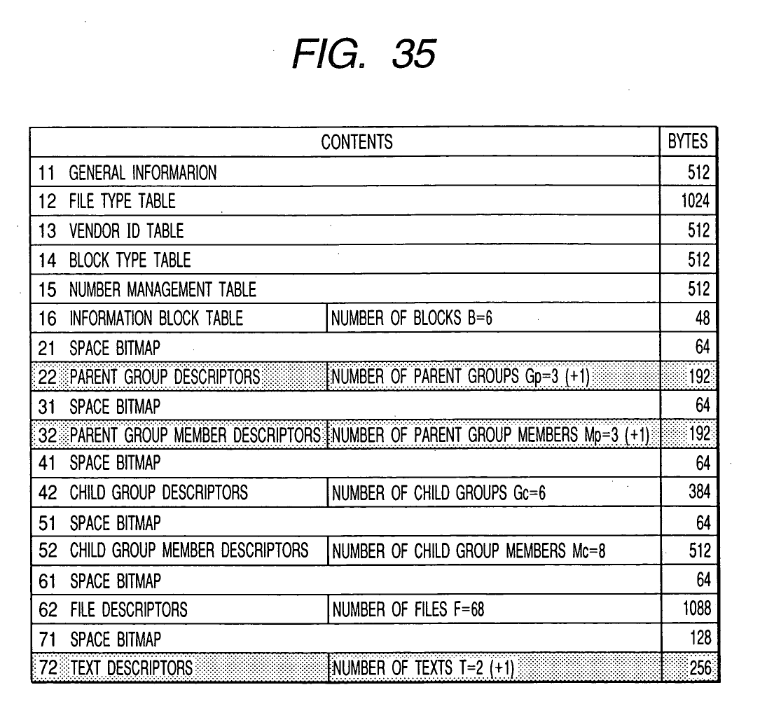

FIG. 35 shows the CMF structure wherein only one parent group with a comment is added, with respect to the state of FIG. 34. In this case there is no change in the directory structure from the state of FIG. 31. Since the newly added parent group contains only 29 or less child groups, one Parent Group Descriptor [22] and one Parent Group Member Descriptor [32] are added. Since the comment is recorded in the Text Information [7], one Text Descriptor [72] is added. For the above modifications at the three portions, the information is updated in the Space Bitmaps [21, 31, 71] of the corresponding Information Blocks and in the Information Block Table [16].

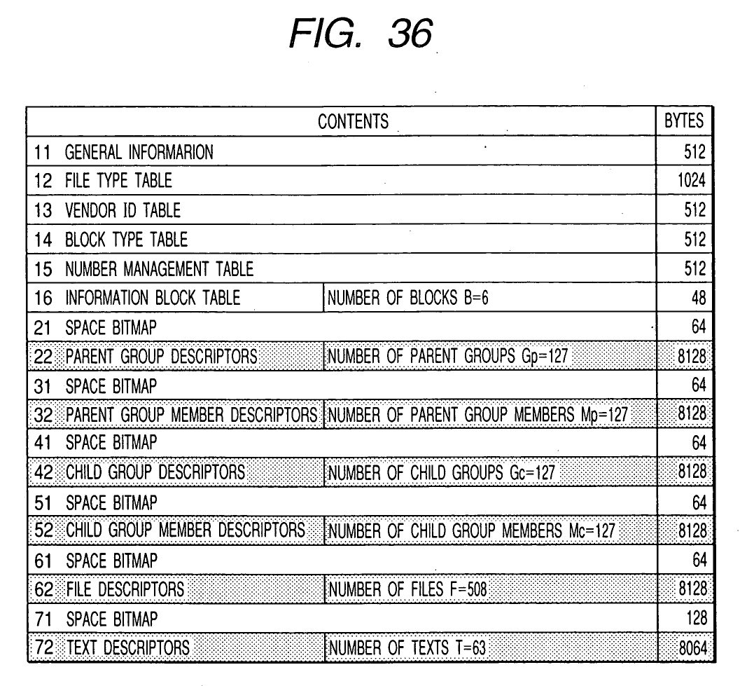

FIG. 36 shows the numbers of data filling up the entire CMF capacity secured at the time of initialization, wherein the number of parent groups, the number of parent group members, the number of child groups, and the number of child group members all are 127, the number of files is 508, and the number of texts 63. In practice, the number of groups never exceeds the number of group members.

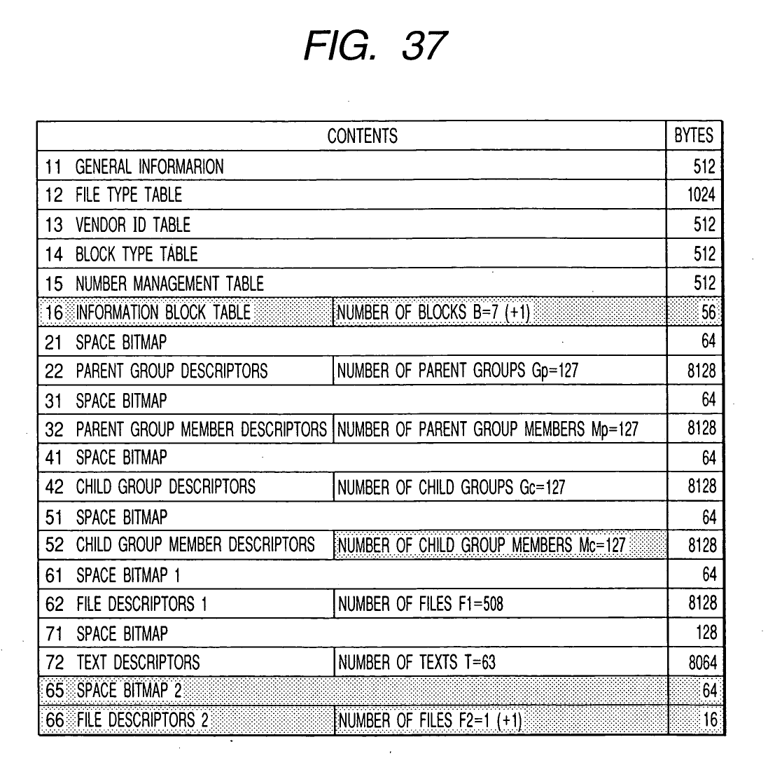

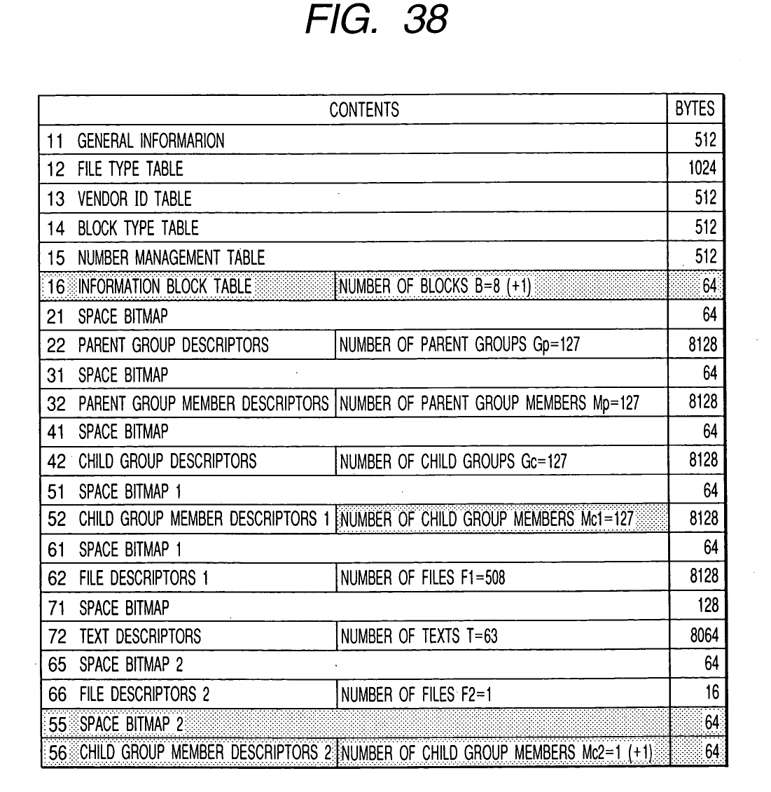

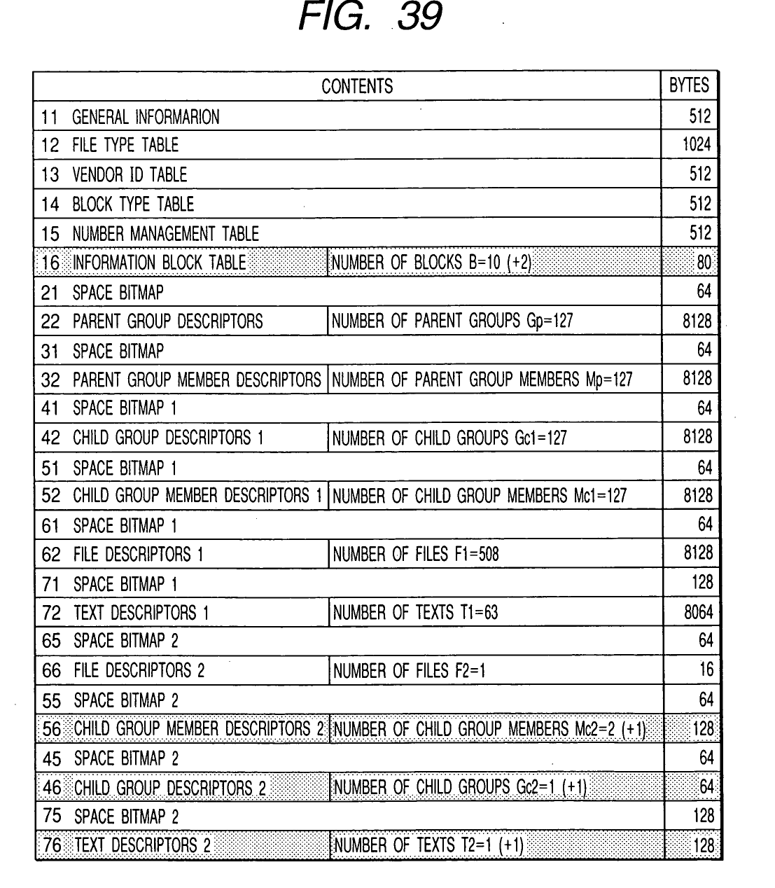

FIG. 37 shows the CMF structure wherein a file is added to the structure in the full state of the CMF obtained at the time of initialization. First, let us suppose that the full state of the CMF is a state wherein the number of parent groups and the number of child groups each are 127, the number of files 508, and the number of texts 63. This example shows that there exists only one Group Member Descriptor per Group Descriptor. When one file information is added in this state, there is no space area in the existing File Information Block 1 [61, 62], and it is thus necessary to add a new File Information Block 2 [65, 66] at the tail of the CMF. After that, a File Descriptor 2 [66] is recorded in the newly added File Information Block 2 [65, 66]. At the same time, the new file is automatically registered in the date group and thus registered as a member of the corresponding Date Child Group Member Descriptor [52]. In conjunction therewith, the information is updated in the corresponding Space Bitmap 2 [65] and the number of blocks is incremented by one in the Information Block Table [16].

FIG. 38 shows the CMF structure wherein a file is added to a child group and a new Child Group Member Information Block is added, with respect to the state of FIG. 37. For adding a member to a group, it can be placed in a space of an existing Group Member Descriptor if present. However, if there is no space it is necessary to create a new Group Member Descriptor. Further, in this example, there is no space area in the existing Child Group Member Information Block 1 [51, 52]. Therefore, a new Child Group Member Information Block 2 [55, 56] is added to the tail of the CMF and a. Child Group Member Descriptor 2 [56] is created. At the same time, it is also necessary to update the Next Member Descriptor ID of the Child Group Member Descriptor 1 [52] ahead of the new Child Group Member Descriptor 2 [56]. In conjunction therewith, the information is updated in the corresponding Space Bitmap 2 [55] and the number of blocks is incremented by one in the Information Block Table [16].

FIG. 39 shows the CMF structure wherein a child group with a comment is added in succession to FIG. 38. Since the existing Information Blocks are full, a new Child Group Information Block and Text Information Block are added. First, a Child Group Information Block 2 [45, 46] for the new child group is added to the CMF and members of the new child group are added to the Child Group Member Descriptors 2 [56]. Further, in order to store the comment having a reference link from the child group, a Text Information Block 2 [75, 76] is added to the CMF and one text information is added to the Text Descriptors 2 [76]. In conjunction therewith, the information is updated in the corresponding Space Bitmaps [45, 55, 75] and the number of blocks is incremented by two in the Information Block Table [16].

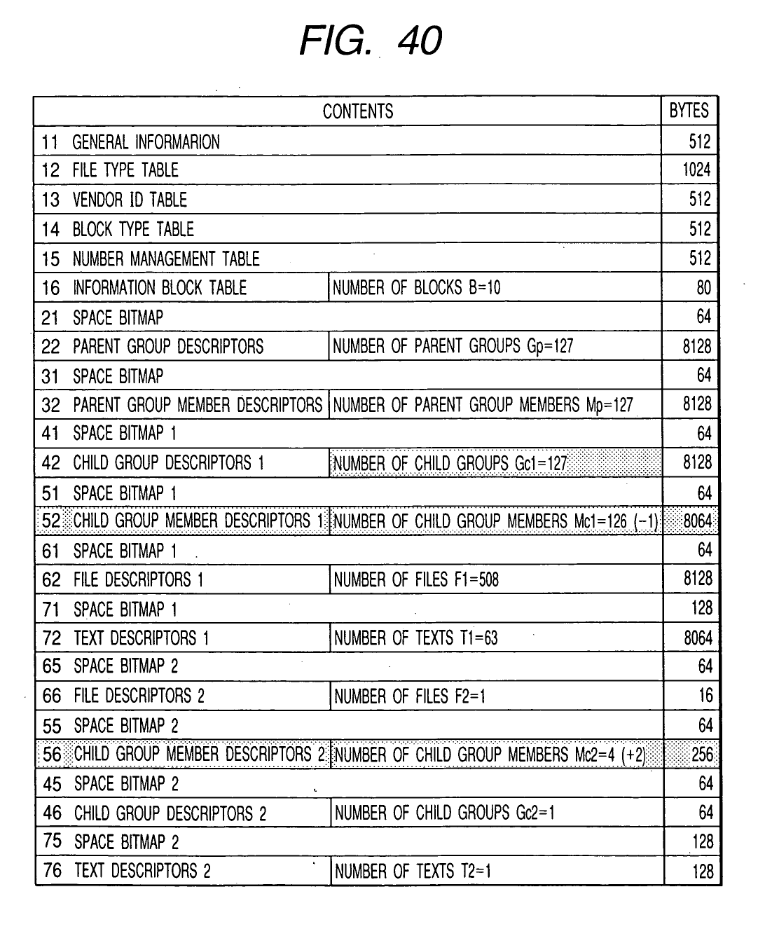

FIG. 40 also shows the CMF structure wherein a file is added to an existing child group, as in FIG. 38, and wherein the Information Block 1 [51, 52] including the child group to accept the added file is already full of data and thus the whole of related group member information is moved to another Information Block 2 [55, 56]. Let us assume that there is only one Child Group Member Descriptor before the addition of the file and one new Child Group Member Descriptor is added thereto. In order to place the whole group in one Information Block, the original Child Group Member Descriptor 1 [52] is first moved from the Child Group Member Descriptors 1 [52] to the Child Group Member Descriptors 2 [56] and a new Child Group Member Descriptor 2 [56] is added thereto. As a result, the number of child groups is incremented by two in the new Child Group Member Descriptors 2 [56] and the number of child groups is decremented by one in the original Child Group Member Descriptors 1 [52]. Further, it is also necessary to update the value of the Group Member Descriptor ID of the Child Group Descriptor 1 [42] having a reference link to the Child Group Member Descriptor. At the last step, the information is also updated in the corresponding Space Bitmaps [51, 55] and in the Information Block Table [16].

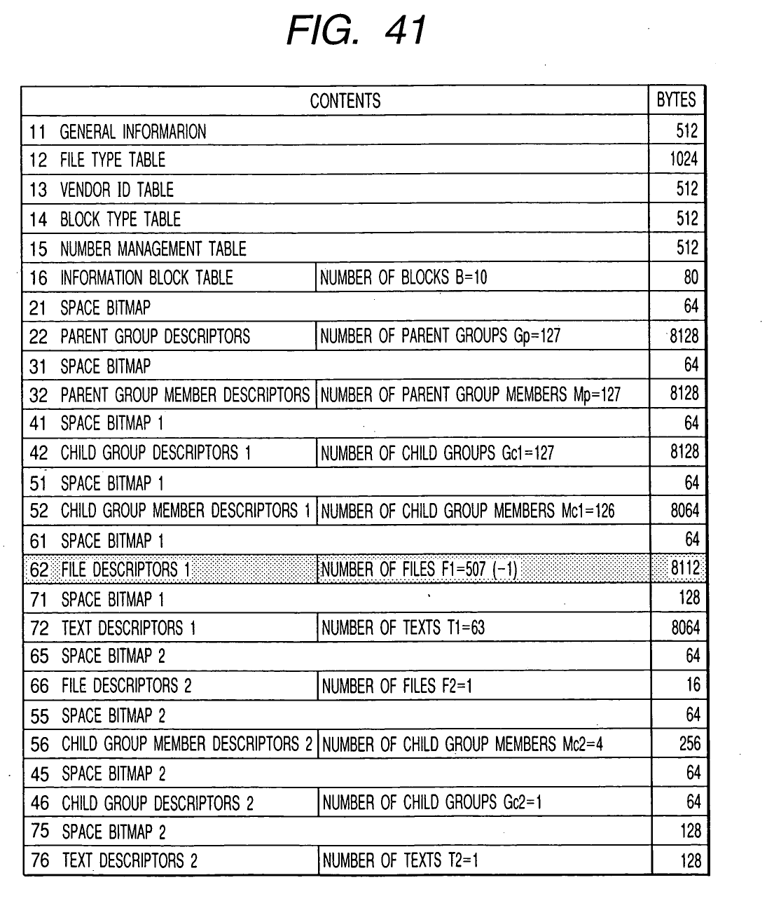

The following will describe cases of deletion of a file or a group. FIG. 41 shows a case where a file in the File Descriptors 1 [62] is deleted and the deletion attribute is added to the File Descriptor deleted. At this time, whether the value at the pertinent portion in the Space Bitmap 1 [61] is to be changed to “0” (deleted) is determined depending upon the value of the Link Count of the deleted file. If the Link Count is 0 the value in, the Space Bitmap 1 [61] may be changed to “0.” If the Link Count is greater than 1, the file has a reference link from either child group and thus the value in the Space Bitmap 1 [61] is kept as “1” to prohibit overwriting. If a change is made in the value in the Space Bitmap 1 [61], the information is also updated in the Information Block Table [16].

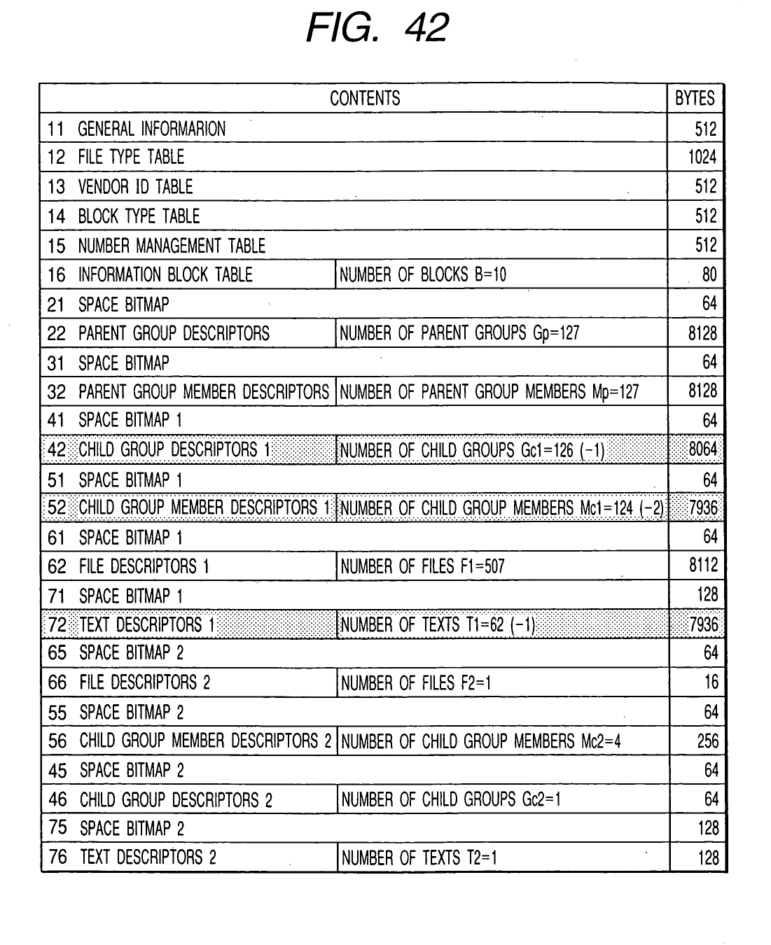

FIG. 42 shows the CMF structure in the case where one Child Group Descriptor, which is information of a child group with a comment having two Child Group Member Descriptors as member information, is deleted. First, the deletion attribute is added to the deleted Group Descriptor in the Child Group Descriptors 1 [42]. At this time, whether the value at the pertinent portion in the Space Bitmap 1 [41] is to be changed to “0” (deleted) is determined depending upon the value of the Link Count of the deleted group. If the Link Count is 0, the value in the Space Bitmap 1 [41] may be changed to “0.” If the Link Count is greater than 1, the group has a reference link from either parent group and thus the value in the Space Bitmap 1 [41] is kept as “1” to prohibit overwriting. Since the Link Count of the parent group is always 0, the value at the pertinent portion in the Space Bitmap may be set to “0” (deleted) on the occasion of deletion of the parent group. The next step is to delete two Child Group Member Descriptors 1 [52] indicating the member information of the deleted child group. This is implemented by setting the value to “0” (deleted) at the pertinent portions in the Space Bitmap 1 [51] corresponding to the position information of the deleted Member Descriptors. Subsequently, the text information is deleted from the Text Descriptors 1 [72] having the reference link from the deleted group. This is also implemented by setting the value to “0” (deleted) at the pertinent portion in the Space Bitmap 1 [71] corresponding to the deleted text. When a change is made in the values in the Space Bitmaps [41, 51, 71] of the three modified Information Blocks as described above, the information is also updated in the Information Block Table [16].

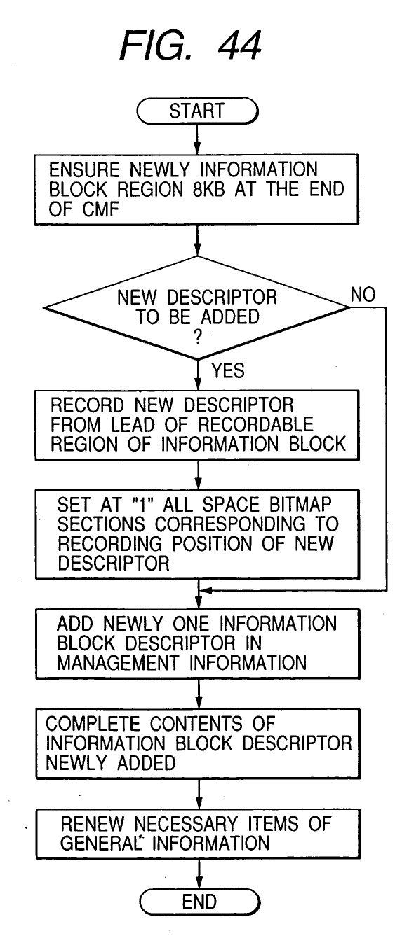

FIG. 44 shows a routine of adding a new Information Block. A new Information Block is added when there is no space area available for additional information of Object Descriptor. The first step is to obtain an area of 8 KB at the end of the CMF. If there is information of a new Descriptor or the like to be added, the necessary information is recorded from the top of the Descriptor recording area following the Space Bitmap and Reserved area, and “1” is set at the portion in the Space Bitmap corresponding to the recording position. After that, a new Information Block Descriptor is added to the Information Block Table in the Management Information and necessary items are recorded therein. When the Information Block Table is modified, pertinent items, e.g., the number of objects and the like, are updated in the General Information.

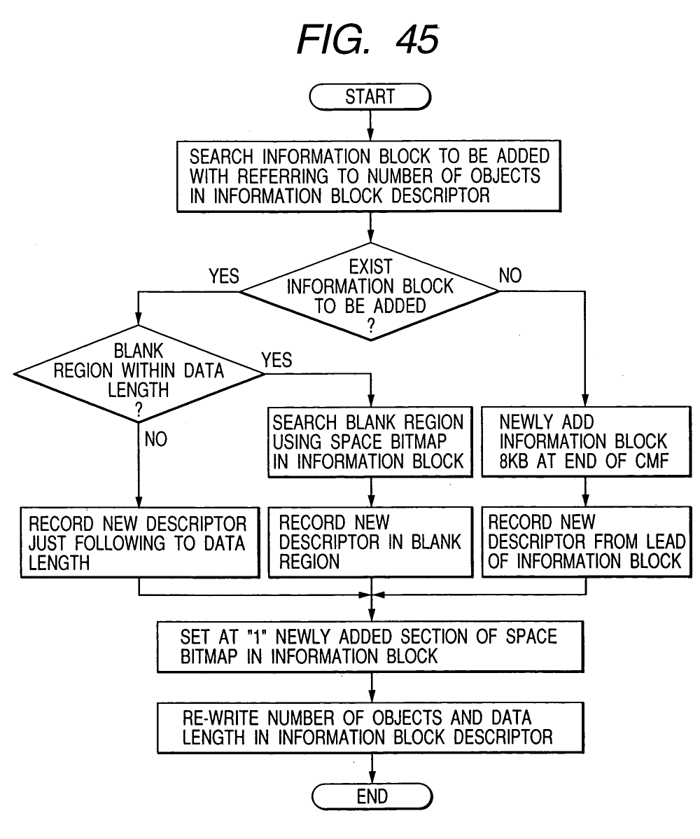

FIG. 45 shows a routine of adding new group, file, or text information (object) whose Descriptor size is the fixed length. Since these information has the recording size of the fixed length, it can be recorded as long as there is even one space area. First, it is determined whether there is free space in the existing Information Block. There is free space if the Number of Objects in the Information Block for the pertinent object is smaller than the maximum recordable number. If there is free space in the existing Information Block the pertinent object can be recorded there. If there is no space a new Information Block is created and the pertinent object is recorded therein. In the recording in the existing Information Block, if the data size calculated from the Number of Objects (size of Space Bitmap area+size of Reserved area+Number of Objects×cell size) is equal to the value of Data Length, there is no space in the area up to the Data Length and thus the information of the new object may be recorded from the site immediately after the Data Length. If the value of Data Length is larger than the data size calculated from the Number of Objects, there exists a space area in the middle, thus the space area is searched for by use of the Space Bitmap, and the information of the new object is recorded therein. If there exists a sufficient area after the Data Length even with a space area in the middle, the recording of the information of the new object may be started from immediately after the Data Length without searching the Space Bitmap. After completion of the recording, the value is set to “1” at the pertinent portion in the Space Bitmap of the same Information Block, the Number of Objects in the Information Block Descriptors is incremented by one, and the Data Length is also increased if necessary. The Data Length is increased only when the newly created object is added to the tail of the effective data length. When the new object is recorded in the deleted area in the middle, the Data Length is not increased.

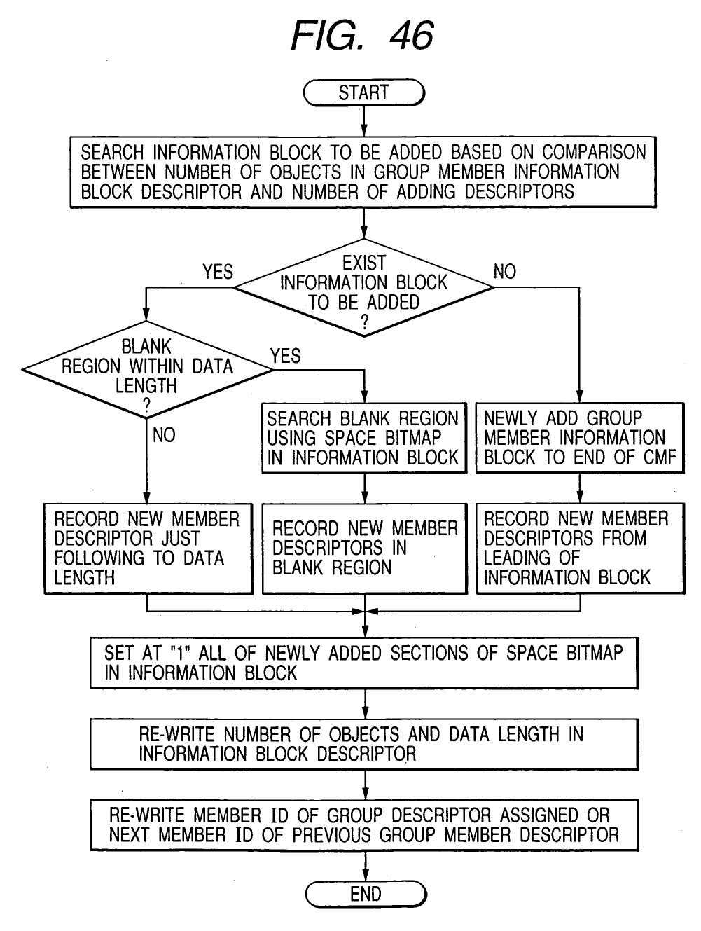

FIG. 46 shows a routine of adding new group member information (object) whose Descriptor size is a variable length. Since the information has the recording size of the variable length, it is necessary to determine whether there is an enough space area. For first determining whether there is an enough space in the existing Information Block, a difference between the maximum recordable number and the Number of Objects in the Information Block for the pertinent object is compared with the recording size. If the existing Information Block has a sufficient space the object can be recorded there. If there is no sufficient space a new Information Block is created and the pertinent object is recorded there. In the occasion of the recording in the existing Information Block, if the data size calculated from the Number of Objects (size of Space Bitmap area+size of Reserved area+Number of Objects×cell size) is equal to the value of Data Length, there is no space in the area up to the Data Length and thus the new object information may be recorded from the site immediately after the Data Length. When the value of Data Length is greater than the data size calculated from the Number of Objects, there exists a space area in the middle, the space area is searched for by use of the Space Bitmap, and the new object information is recorded there. If there exists a sufficient area after the Data Length even with a space area in the middle, the recording may be started from immediately after the Data Length without searching the Space Bitmap. After completion of the recording, the value of “1” is set at the pertinent portion in the Space Bitmap of the same Information Block, the Number of Objects in the Information Block Descriptors is incremented by the number of added objects and the Data Length is also increased if necessary. The Data Length is increased only when the newly created object is added to the tail of the effective data length. The Data Length is not increased when the object is recorded in the deleted area in the middle. When the group member information is added, it is necessary to update the Group Member ID of the Group Descriptor having a reference link to the Group Member Descriptor of the added group member, or the Next Member ID of the Group Member Descriptor immediately before the added Group Member Descriptor, to the new Member Descriptor ID.

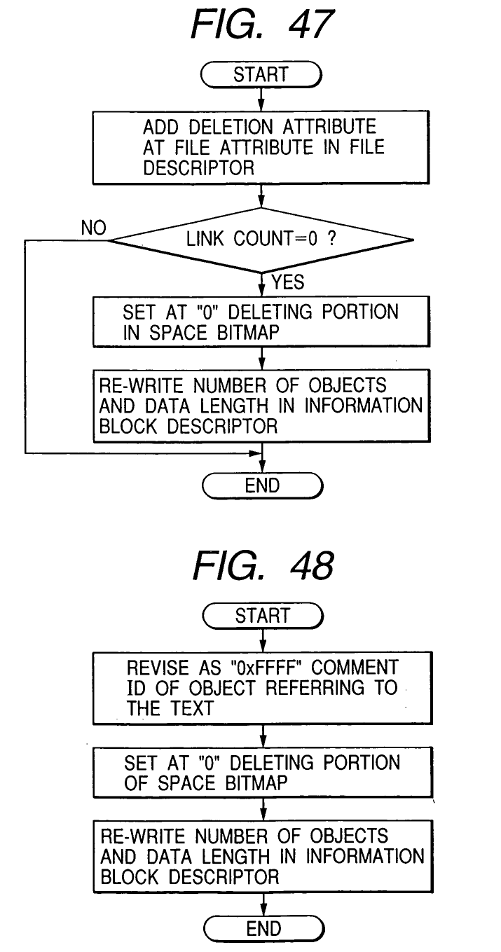

The following will describe a routine of deleting an object. FIG. 47 shows a routine of deleting file information. First, the deletion attribute is added to the File Attribute in the File Descriptor. When the Link Count is 0, the value of “0” is set at the deleted portion in the Space Bitmap of the same Information Block, the Number of Objects in the Information Block Descriptors is decremented by one, and the Data Length is also decreased if necessary. When the Link Count is not 0, no change is made in the Space Bitmap and in the associated Information Block Descriptor in order to avoid overwriting. At this time, the Data Length is decreased only when the deleted object is one located at the last of the effective data length. The Data Length is not decreased when an intermediate area is deleted.

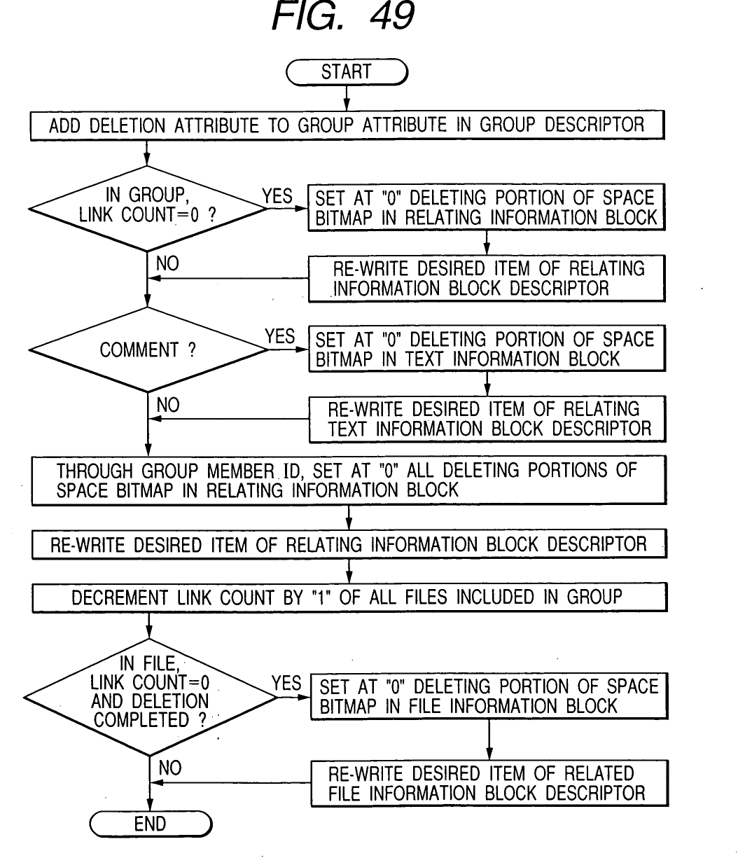

FIG. 48 shows a routine of deleting text information. When the deleted object is a text, it is necessary to separate the text from a group having a reference link thereto. Therefore, the value of Comment ID of the group is set to 0×FFFF to indicate no-comment. After that, “0” is set at the deleted portion in the Space Bitmap of the same Information Block, the Number of Objects in the Information Block Descriptors is decremented by one, and the Data Length is also decreased if necessary. At this time, the Data Length is decreased only when the deleted object is one at the last of the effective data length. The Data Length is not decreased when an intermediate area is deleted.

FIG. 49 shows a routine of deleting child group information. First, the deletion attribute is added to the Group Descriptor of a child group to be deleted. At this time, since the deleted portion may be overwritten in the case of the Link Count of 0, the value of “0” is set at the deleted portion in the Space Bitmap. The Number of Objects in the Information Block Descriptors is decremented by one, and the Data Length is also decreased if necessary. If the group has a comment, a corresponding text in the Text Information is then deleted. Thereafter, all the Group Member Descriptors included in the child group are deleted according to the Group Member IDs. At the final step all the Link Counts of the files included in the child group are decremented by one each. At this time, if a file is deleted and if the Link Count thereof is 0, the value of “0” is set at the pertinent portion in the Space Bitmap of the Information Block to which the file belongs, to permit overwriting, the Number of Objects in the Information Block Descriptors is decremented by one, and the Data Length is also decreased if necessary. The Data Length is decreased only when the deleted object is one at the last of the effective data length. The Data Length is not decreased when an intermediate area is deleted.

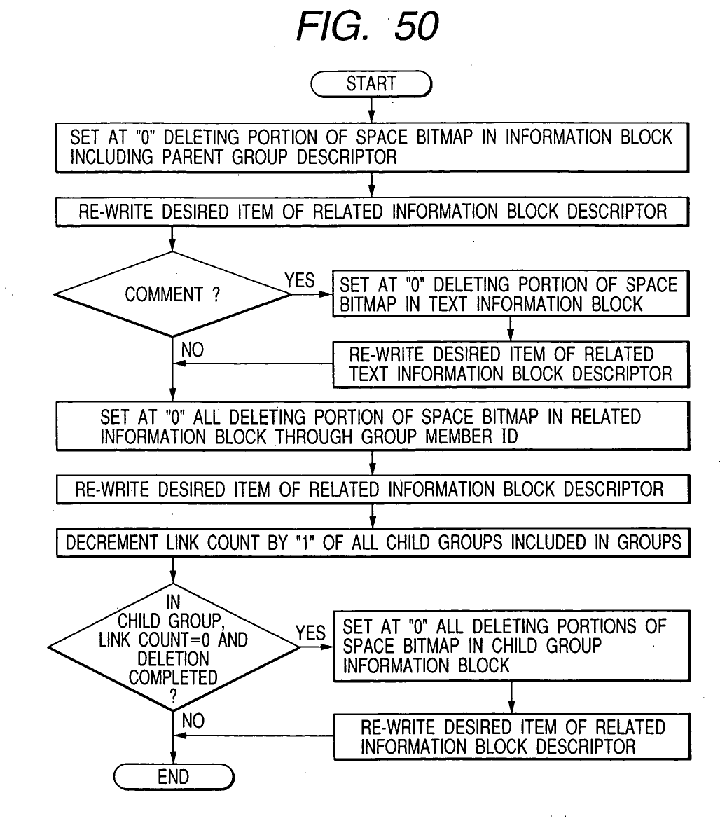

FIG. 50 shows a routine of deleting parent group information. Since a parent group always has the Link count of 0, the Group Descriptor thereof may be completely deleted. The value of “0” is set at the deleted portion in the Space Bitmap, the Number of Objects in the Information Block Descriptors is decremented by one, and the Data Length is also decreased if necessary. At this time, the Group Descriptor is completely deleted and it is thus unnecessary to add the deletion attribute, different from the case of deletion of the child group. If the parent group has a comment, a corresponding text in the Text Information is deleted. After that, all the Group Member Descriptors included in the parent group are deleted according to the Group Member IDs. At the final step all the Link Counts of child groups included in the parent group are decremented by one each. At this time, if a child group is deleted and if the Link Count thereof is 0, the value of “0” is set at the pertinent portion in the Space Bitmap of the Information Block to which the child group belongs, to permit overwriting, the Number of Objects in the Information Block Descriptors is decremented by one, and the Data Length is also decreased if necessary. The Data Length is decreased only when the deleted object is one at the last of the effective data length. The Data Length is not decreased when an intermediate area is deleted.

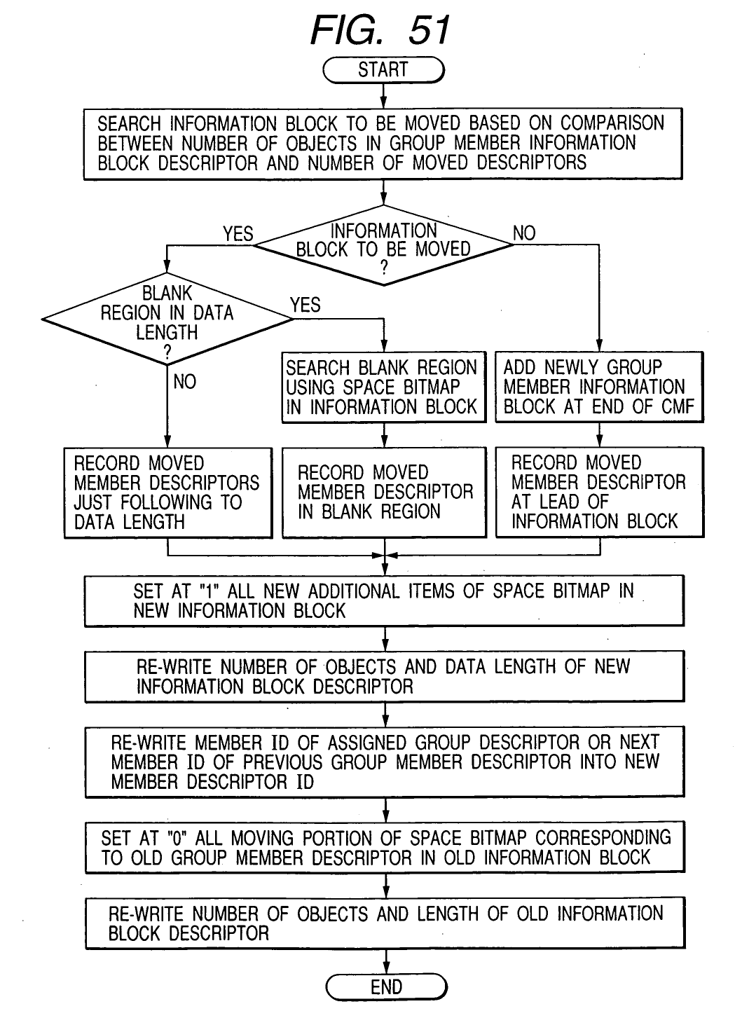

FIG. 51 shows a routine of moving group member information (object). Since the information has the recording size of a variable length, it is necessary to determine whether the space area is sufficient. For first determining whether the existing Information Block has a sufficient space, the recording size is compared with a difference between the maximum recordable number and the Number of Objects in the Information Block for the pertinent object. If the existing Information Block has a sufficient space, the object can be moved thereto. If the space is insufficient, a new Information Block is created and the pertinent object is moved thereto. In the case of the object being moved into the existing Information Block, if the data size calculated from the Number of Objects (size of Space Bitmap area+size of Reserved area+Number of Objects×cell size) is equal to the value of Data Length, there is no space in the area up to the Data Length, and the object information to be moved may be recorded from the site immediately after the Data Length. If the value of Data Length is larger than the data size calculated from the Number of Objects, there exists a space area in the middle, the space area is searched for by use of the Space Bitmap, and the object information to be moved is recorded there. If there exists a sufficient area after the Data Length even with a space area in the middle, the recording may be started from immediately after the Data Length without searching the Space Bitmap. After completion of the movement, the value of “1” is set at the pertinent portion in the Space Bitmap of the Information Block to which the object was moved, the Number of Objects in the Information Block Descriptors is incremented by one, and the Data Length is also increased if necessary. The value of the Member ID of the Group Descriptor to which the moved group member belongs, or the value of the Next Member ID of the previous Group Member Descriptor is rewritten into a new Member Descriptor ID. At the final step, the value of “0” is set at the pertinent portion in the Space Bitmap of the old Group Member Information Block, the Number of Objects in the Information Block Descriptors is decremented by one, and the Data Length is also decreased if necessary.

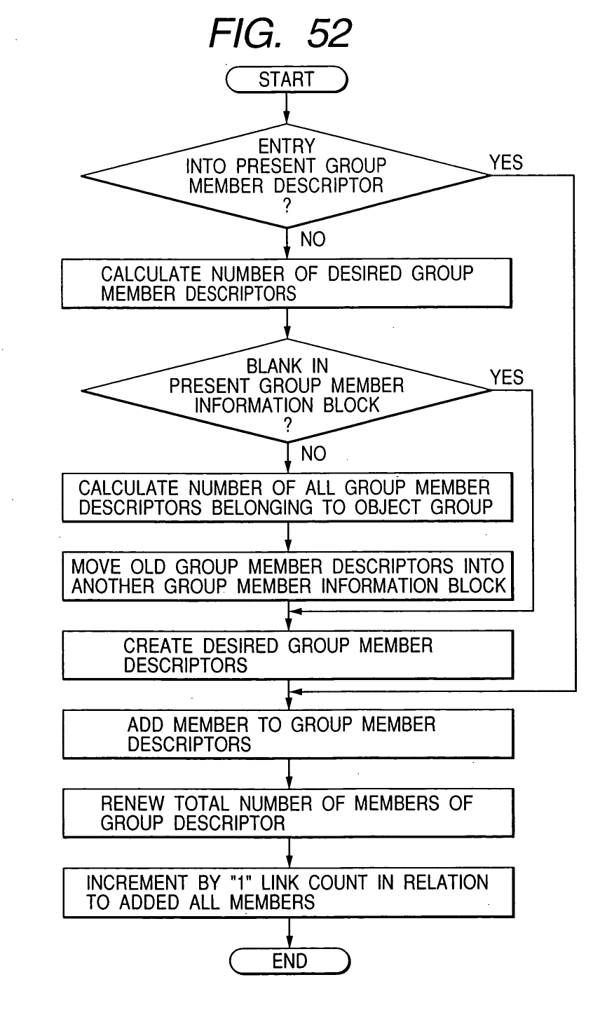

The following will describe adding/deleting routines of a member (an object such as a child group, a file, or the like) included in a parent group or a child group. FIG. 52 shows a routine of adding a member to a group. If there is a space area enough to add a member in the Group Member Descriptor of the desired group, an object ID is simply added into the objective Group Member Descriptor. The information of Total Number of Members is updated, and thereafter the Link Count of each added object is incremented by one. If the space area is insufficient, a necessary number of Group Member Descriptors are added in the same Group Member Information Block. At this time, if the space area is not enough to add the Group Member Descriptors in the Group Member Information Block including the Group Member Descriptor to which the object is desired to be added, all the Group Member Descriptors belonging to one group may be moved into another Group Member Information Block. If no space area is found in the existing Group Member Information Block, a new Group Member Information Block is created.

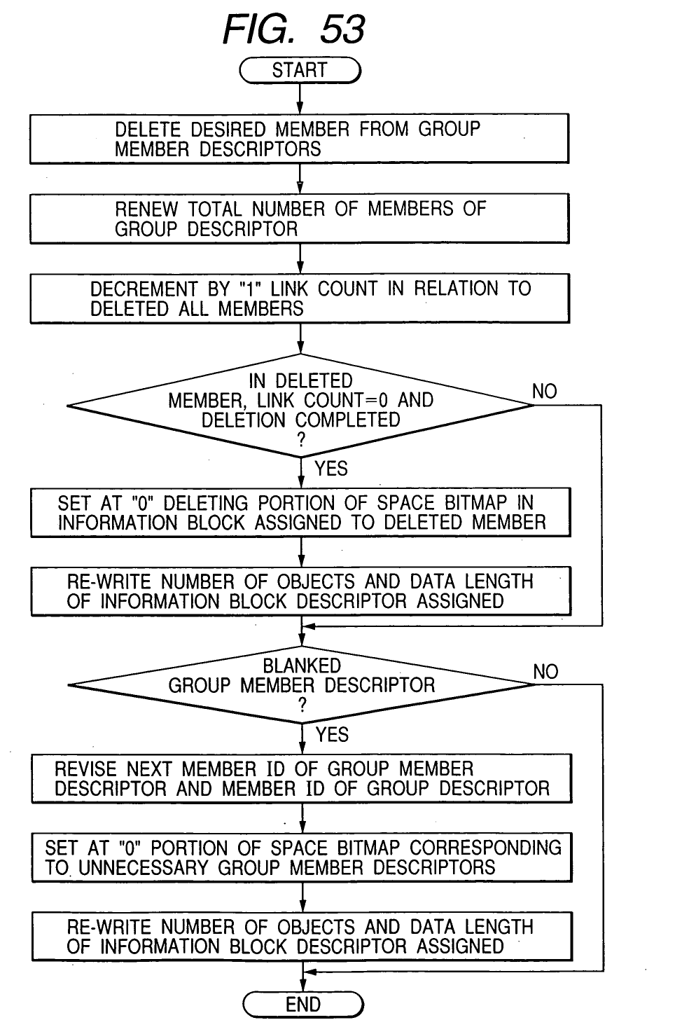

FIG. 53 shows a routine of deleting members (objects such as child groups, files, or the like) included in a parent group or a child group. The members to be deleted are first deleted from the Group Member Descriptors, the information of Total Number of Members is updated, and thereafter the Link Counts of the deleted objects are decremented by one each. At this time, if an object is deleted and if the Link Count thereof is 0, the value of “0” is set at the pertinent portion in the Space Bitmap of the Information Block to which the object belongs, the Number of Objects in the Information Block Descriptors is decremented by one, and the Data Length is also decreased if necessary. Further, when the deletion of members from the group results in yielding Group Member Descriptors including no member, the Next Member Descriptor IDs are revised throughout the entire group and the unnecessary Group Member Descriptors are deleted.

### INDUSTRIAL APPLICABILITY

As described above, the provision of the CMF (Contents Management File), which is a file for totally managing all necessary files and groups, permits the applications to handle a lot of files through the CMF without use of the file system and perform necessary processing such as grouping or the like with general versatility. For example, in the case of time series display of plural files, the files are grouped according to the order of dates, or the file information is recorded in time series in the CMF, and the files are reproduced in order. The hierarchical structure of the group information in the layers of parent groups and child groups also facilitates the management of groups.

Since the CMF has a list of members (objects such as child groups, files, or the like) included in each group and each object has the link counter being the number of groups to which the object belongs, it becomes feasible to instantly retrieve a list of members included in a certain group and readily determine whether a certain object is included in either group. This facilitates warning or the like on the occasion of deleting an object included in either group.

When the extensions are expressed by one byte through the use of the table in the CMF, the information size for file names can be decreased. Further, the extension table is configured to handle even identical extensions as different extensions depending upon their types, whereby the types of files can be categorized independently of the extensions. When the files themselves are also provided with subsidiary file attributes, they can be discriminated among general video, audio, and so on.

Although the group member information has the variable size depending upon the number of members included, it becomes feasible to perform efficient processing of addition, deletion, etc., by using connected areas (cells) of the fixed length size (64 bytes). Since the group information and member information is recorded in the separate state over the areas (Blocks) of the fixed length (8 KB) and the sequential member information belonging to the same group is recorded in the same Block, the readout efficiency is enhanced. Further, since a comment of a group is recorded in another Block, the storage efficiency is enhanced when a group without a comment or the like is recorded.

The space areas in each Block are managed by the Space Bitmap in the Block and the number of space areas and the data length in each Block are managed by the management Block at the top of the CMF, whereby it becomes feasible to decrease the size of data resident on the memory and decrease the amount of search. Further, a file or a group is designated by an order of a recorded position thereof, which eliminates a need for possession of its own ID number in the file information or the group information, which decreases the size, and which eliminates a need for a search process in the designation of the file information or the group information.

1. A method of managing files recorded on an information recording medium, wherein there is provided a Contents Management File including group information of a plurality of groups into which a plurality of files recorded on said medium are grouped and wherein management of the groups and files is carried out by means of the Contents Management File.

2. The file management method according to claim 1, wherein said Contents Management File comprises a record of a plurality of Information Blocks of a fixed length storing information of the groups and files.

3. The file management method according to claim 2, wherein each said Information Block comprises a plurality of cells being information storage units of a fixed length, and a Space Bitmap for managing states of use of the respective cells.

4. The file management method according to claim 3, wherein a size and a number of said cells included in each Information Block differ according to a type of the Information Block including the cells.

5. The file management method according to claim 3, wherein an ID specifying individual information included in each said cell is managed by a number corresponding to a storage position of the cell.

6. The file management method according to claim 2, wherein each said Information Block has a size equal to a quotient of an error correction unit (ECC block) of said recording medium by a power of 2 (1, 2, 4, 8, 16, . . . ).

7. The file management method according to claim 2, wherein when there exists no space area in said Information Block, an area is obtained by adding a block of the same size.

8. The file management method according to claim 1, wherein said Contents Management File includes a record of Management Information of the entire Contents Management File including general information, a list of types of files, a list of data creators, a list of types of Information Blocks, a list of numbers of data included in the respective Information Blocks, and information block management information.

9. The file management method according to claim 8, wherein said information block management information bears information about a location of each said Information Block in said Contents Management File.

10. The file management method according to claim 8, wherein said information block management information comprises a record of information indicating a number of effective cells included in each said Information Block.

11. The file management method according to claim 8, wherein said information block management information comprises information indicating an effective data length of each said Information Block.

12. The file management method according to claims 10 and 11, wherein in said Information Block, whether a space area within an effective data length is present or absent is determined by comparison between said number of effective cells and said effective data length, whereby a recording position of data to be recorded in said Information Block can be determined without using said Space Bitmap.

13. The file management method according to claim 8, wherein even when said Contents Management File contains the block management information equivalent to a maximum number of Information Blocks that can be recorded in said Contents Management File, said Management Information does not exceed an initial size.

14. The file management method according to claim 1, wherein said group information is of a hierarchical configuration permitting even grouping of groups and said hierarchical configuration is a configuration of at least two levels consisting of child group information for management of grouping of files and parent group information for management of grouping of said child group information.

15. The file management method according to claim 1, wherein at least one of said group information is a group based on a recording sequence of said files.

16. The file management method according to claim 2, wherein said Information Block contains said group information.

17. The file management method according to claim 2, wherein said Information Block contains member information of said groups.

18. The file management method according to claim 2, wherein said Information Block contains file information for management of said files.

19. The file management method according to claim 2, wherein said Information Block contains text information storing a character string.

20. The file management method according to claim 19, wherein said text information contains a character string describing contents of said group information.

21. The file management method according to claim 16, wherein said group information contains an ID number of said text information associated with a pertinent group.

22. The file management method according to claim 19, wherein-said text information contains an ID number of a group having a reference link to a text.

23. The file management method according to claim 19, wherein said text information contains length information about a length of a text and character information consisting of a character code identical to that of a file system.

24. The file management method according to claim 17, wherein said group member information is comprised of units of said cells (Group Member Descriptors) of a fixed size and group member information having an information volume exceeding said size is recorded over a plurality of cells.

25. The file management method according to claim 24, wherein group member information constituting one group is recorded in a single block of said Information Block.

26. The file management method according to claim 1, wherein each file can be managed by a plurality of child group information and each file information contains information (Link Count) indicating a number of child groups to which said file itself belongs.

27. The file management method according to claim 1, wherein each child group information of a child group can be managed by a plurality of parent group information and each child group information contains information (Link Count) indicating a number of parent groups to which said child group itself belongs.

28. The file management method according to claim 26, wherein when the Link Count of said file is a value except for zero, overwriting on said file is prohibited even after the file is deleted.

29. The file management method according to claim 27, wherein when the Link Count of said child group information is a value except for zero, overwriting on said child group information is prohibited even after the child group information is deleted.

30. The file management method according to claim 26, wherein when deletion of a certain file is found during use of a list of files included in said child group information, the file is deleted from the child group, the Link Count of said file is decremented by one, and an area of the file information is set into an overwritable state when the Link Count becomes 0.

31. The file management method according to claim 27, wherein when deletion of a certain child group is found during use of a list of child groups included in said parent group information, the child group is deleted from the parent group, the Link Count of said child group is decremented by one, and an area of the child group information is set into an overwritable state when the Link Count becomes 0.

32. The file management method according to claim 1, wherein said Contents Management File manages as one of child group information, a file describing an order of reproduction or display or print of a plurality of files.

33. The file management method according to claim 14, wherein said child group information each contains information indicating a representative file.

34. The file management method according to claim 33, wherein said representative file is a top member belonging to the child group information.

35. The file management method according to claim 14, wherein said parent group information each contains information indicating a representative child group.

36. The file management method according to claim 35, wherein said representative child group is a top member belonging to a parent group thereof.

37. The file management method according to claim 18, wherein in said file information extensions of the files are managed by identification information of one byte and said Management Information comprises a correspondence table (File Type Table) between each extension and the identification information.

38. The file management method according to claim 37, wherein when identical extensions are different in use, different identification information pieces are assigned to the respective extensions.

39. The file management method according to claim 18, wherein said file information contains subsidiary attribute information indicating contents of files in order to facilitate identification of files within an identical extension.

40. The file management method according to claim 8, wherein said general information contains UUID information as a Disk ID.

41. The file management method according to claim 8, wherein among a plurality of disks, said UUID information and update dates and times recorded in the respective disks are compared, whereby it is determined whether information included in a disk is coincident with information included in another disk and whether a disk is a copy of another disk.

42. The file management method according to claim 8, wherein said general information contains information indicating an initialization date and time and a creation date and time of the Contents Management File and whether a recorded disk is a copy of another disk is determined based on whether said information of the initialization date and time and the creation date and time agrees with each other.

43. The file management method according to Claim.8, wherein said Contents Management File comprises information indicating information of a file or a group to be automatically started at the time of loading of a disk or at the time of application of power.

44. The file management method according to claim 8, wherein said Contents Management File comprises information indicating whether a disk is to be automatically started.
